(19) United States
(12) Patent Application Publication
(10) Pub. No.: US 2026/0028441 A1
(43) Pub. Date: Jan. 29, 2026

(54) FOLDABLE BOTTLEBRUSH POLYMERS, FOLDABLE BOTTLEBRUSH POLYMER NETWORKS, AND METHOD OF MAKING FOLDABLE BOTTLEBRUSH POLYMERS AND NETWORKS

(71) Applicant: University of Virginia Patent Foundation, Charlottesville, VA (US)

(72) Inventors: Liheng Cai, Charlottesville, VA (US); Baiqiang Huang, Charlottesville, VA (US)

(21) Appl. No.: 19/217,358

(22) Filed: May 23, 2025

Related U.S. Application Data
(60) Provisional application No. 63/675,180, filed on Jul. 24, 2024.

(51) Int. Cl. C08F 290/06; H01M 10/052; H01M 10/0565

(52) U.S. Cl. CPC C08F 290/062; H01M 10/052; H01M 10/0565; H01M 2300/0082

(57) ABSTRACT

The present disclosure provides for foldable bottlebrush polymers, foldable bottlebrush polymer networks, method of making foldable bottlebrush polymers and networks, conductive electrolytes including the foldable bottlebrush polymer networks, and the like.

### CROSS-REFERENCE TO RELATED APPLICATIONS

This application claims the benefit of U.S. Provisional Application entitled “3D PRINTING OF MOLECULAR ARCHITECTURE ENCODED MODULAR STRETCHABLE PEG HYDROGELS AND ELASTOMERS” and having Ser. No. 63/675,180, filed Jul. 24, 2024, which is herein incorporated by reference in its entirety.

### FEDERAL SPONSORSHIP

This invention was made with government support under 1944625 awarded by the National Science Foundation. The government has certain rights in the invention.

### BACKGROUND

Polyethylene glycol (PEG) hydrogels are among the most widely used synthetic biomaterials for basic and translational biomedicine. Without solvents, PEG networks emerge as solid-state polymer electrolytes for next-generation lithium batteries. The application of PEG networks can be greatly expanded by leveraging additive manufacturing, which allows for the rapid fabrication of complex structures with intricate geometric layouts. Conventional PEG networks formed by crosslinking linear PEG polymers are intrinsically brittle. In the presence of solvent, PEG gels exhibit low stretchability because of inhomogeneous, short network strand sizes. Under large deformations, stress tends to concentrate along relatively short network strands, causing premature network failure. Thus, there is a need to advance the chemistry involving PEG hydrogels.

### SUMMARY

The present disclosure provides for foldable bottlebrush polymers, foldable bottlebrush polymer networks, method of making foldable bottlebrush polymers and networks, conductive electrolytes including the foldable bottlebrush polymer networks, and the like.

The present disclosure provides for composition comprising: a foldable bottlebrush polymer network, wherein the foldable bottlebrush polymer network includes at least one polymer strand, wherein the polymer strand includes a polymer backbone having a spacer unit and a monofunctional polyethylene glycol (PEG) side chain, wherein the foldable bottlebrush polymer network has at least two of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ratio (rₛₚ) of about 1 to 5, and an average number of side chains per foldable bottlebrush polymer network strand (n_{sc}) of about 20 to 1000.

The present disclosure provides for a method of making a foldable bottlebrush polymer network, comprising: mixing a spacer unit monomer, a monofunctional polyethylene glycol (PEG) side chain monomer, a difunctional PEG crosslinker unit monomer, and a photoinitiator to form a photocurable resin; disposing the photocurable resin onto a surface; and exposing the photocurable resin for a time period to form a composition including the foldable bottlebrush polymer network.

The present disclosure provides for an electrolyte comprising a composition that includes a lithium salt and a foldable bottlebrush polymer network, wherein the foldable bottlebrush polymer network includes at least one polymer strand, wherein the polymer strand includes a polymer backbone having a spacer unit and a monofunctional polyethylene glycol (PEG) side chain, wherein the foldable bottlebrush polymer network has at least two of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ration (rₛₚ) of about 1 to 5, and an average number of side chains per foldable bottlebrush polymer network strand (n_{sc}) of about 20 to 1000.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1G illustrate the design and chemistry of 3D printable stretchable bottlebrush PEG resins. FIGS. 1A-C illustrate conventional PEG resins consist of relatively long linear PEG (6,000 g/mol) and water, which can be UV-cured to form a randomly crosslinked network. These hydrogels are brittle because of the wide distribution and limited size of the network strands. After solvent removal, the linear PEG network strands crystallize, resulting in stiff and brittle networks. FIG. 1D illustrates the bottlebrush PEG resin is composed of three precursors: (i) monofunctional PEG methyl ether acrylate (480 g/mol) as side chains, (ii) small N-isopropylacrylamide (NIPAM) as spacer monomers, and (iii) a difunctional PEG diacrylate (575 g/mol) as crosslinking chains. These monomers can be dissolved in water at very high concentrations, forming colorless, optically transparent, low-viscosity solutions that can be UV-crosslinked in ambient air. FIGS. 1E-1F illustrates the cured resins form a randomly crosslinked bottlebrush polymer network defined by three parameters, [n_{sc}, rₛₚ, c]. Here, n_{sc} is the average number of side chains per network strand, which equals the molar ratio between the side chains and the crosslinking chains, rₛₚ is the spacer-to-side chain molar ratio, and cis the polymer concentration of the resin. Within the bottlebrush network strand, the NIPAM-based backbone tends to fold, storing length that can be released upon large deformations, enabling highly stretchable networks. FIG. 1G illustrates photos of a foldable bottlebrush PEG elastomer ([400, 5, 100]) stretched by ˜1400% strain. The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

FIGS. 2A-2H illustrate data regarding bottlebrush PEG hydrogels. FIGS. 2A-2E illustrate conventional bottlebrush (cBB) hydrogels without spacers. FIG. 2A illustrates the frequency dependence of the storage (G′, solid symbols) and loss (G″, open symbols) moduli of representative cBB PEG hydrogels measured at 20° C. with a fixed strain of 0.5%. Different symbols represent hydrogels with various crosslinking chain/side chain ratios (PEGDA: PEG).

FIG. 2B illustrates the dependence of equilibrium shear modulus G on the number concentration of crosslinking chains, 1/(n_{sc}+1). FIG. 2C illustrates the stress-strain curves for hydrogels with the same polymer concentration (c) but a different number of side chains (n_{sc}). FIG. 2D illustrates the stress-strain curves for hydrogels of different polymer concentrations. FIG. 2E illustrates the correlation between the Young's modulus (E) and tensile breaking strain (ϵ_{b}) of hydrogels. Circles: change n_{sc} in (FIG. 2C); squares, change c in (FIG. 2D). FIG. 2F-2H illustrates the foldable bottlebrush (fBB) PEG hydrogels. FIG. 2F illustrate the stress-strain curves of PEG hydrogels with a fixed polymer concentration (c=50 wt %) and a fixed number of side chains (n_{sc}=400), but varying ratios of NIPAM spacer monomers (rₛₚ from 0 to 5). FIG. 2G illustrates the dependence of Mooney-Rivlin stress, s/(λ−1/λ²), on 1/λ, where λ=ϵ+1 is the extent of elongation. FIG. 2H illustrates the dependence of differential modulus (K′) on pre-shear stress (T). The stress-softening is attributed to the unfolding of collapsed bottlebrush PEG backbone at large deformations (inset).

FIGS. 3A-3J illustrates data relating to bottlebrush PEG elastomers. FIGS. 3A-C illustrate conventional bottlebrush PEG elastomers without spacers: FIG. 3A illustrates stress-strain curves, FIG. 3B illustrates the comparison between hydrogels (circles, c=71 wt %) and solvent-free networks (squares, c=100%) in the correlation, E∝(ϵ_{b})^{-α}, and FIG. 3C illustrates five hundred consecutive cycles 6-fold (500% strain) loading and unloading for an elastomer [2000, 0, 100]. Horizontal shifts are applied to the curves for the 10^{th}, 50^{th}, 100^{th}, 200^{th}, and 500^{th} cycles for clarity. FIGS. 3D-G illustrate foldable bottlebrush PEG elastomers with NIPAM spacers: FIG. 3D illustrates stress-strain curves, dependencies of FIG. 3E illustrates the tensile breaking strain and FIG. 3F illustrates the Young's modulus E on the spacer ratio for hydrogels (circles, c=50 wt %) and elastomers (squares), and FIG. 3G illustrates consecutive cyclic tensile tests of a foldable bottlebrush PEG elastomer ([400, 5, 100]) with increasing strain up to fracture. All measurements are performed in ambient air. FIG. 3H illustrates DSC measurements reveal the T_{c} of long linear PEG (6 kDa, black line) networks and cBB PEG (red line) networks. FIG. 3I illustrates small-angle X-ray scattering of solvent-free bottlebrush PEG networks. FIG. 3J illustrates ashby-type plot of printable PEG networks and not printable slide-ring PEG hydrogels (Table S1).

FIGS. 4A-4G illustrates applications of photocurable bottlebrush PEG networks. FIGS. 4A-4C illustrate a cBB PEG network ([2000, 0, 100]) is used as a matrix for creating highly stretchable, highly conductive ionic elastomers. FIG. 4A illustrates stress-strain curves of a cBB PEG ionic elastomer containing 30 vol % LiTFSI salts; FIG. 4B illustrates a Nyquist plot of the impedance spectra for the ionic elastomer at RT. Insets: (upper) schematic illustration of the measurement setup and sample dimensions; (lower) a circuit model used for fitting the data. FIG. 4C illustrates Ashby-type plot of solvent-free ionic elastomers based on ionic conductivity and tensile breaking strain. Green circle: bottlebrush PEG ionic elastomer; other symbols: literature data (Table S2). Error bar: standard deviation, n=3. FIG. 4D illustrates photos of 3D printed structures using resin [400, 5, 50]: (i) a kidney, (ii) a hollow heart filled with red-colored water to visualize the hollow structure, (iii) a 3D lattice structure swollen in copper (II) nitrate solution, and (iv) a solvent-free gyroid. Scale bars: 10 mm. FIG. 4E illustrates fluorescence confocal images of NIH 3T3 fibroblasts cultured in aqueous extracts from printed PEG hydrogels with spacer ([400, 5, 50]) and without spacer ([400, 0, 50]) across 1 to 5 days. Scale bars: 200 μm. Cytocompatibility test reveals consistently high cell viability (˜95%) across all samples. FIG. 4F illustrates multi-material DLP printing of two different resins, cBB PEG ([400, 0, 100], E˜17 kPa, green) and fBB PEG ([400, 5, 100], E˜200 kPa, yellow), into a linear structure with alternating stiffnesses that can be twisted, bent, and stretched without interface failure. FIG. 4G illustrates a printed pneumatic gripper operating under 20 kPa compressed air to pick up a mushroom. Scale bars: 20 mm.

FIGS. 5A-5C illustrate real-time monitoring of the photopolymerization for foldable bottlebrush PEG polymers. FIG. 5A is a schematic of the photopolymerization for the foldable bottlebrush PEG polymer. FIG. 5B illustrates ¹H NMR spectra of the reaction mixture containing the PEG side chains and NIPAM spacers at different time points from 0.5 to 90 s in deuterium oxide water. Conversion of NIPAM (sp)=(1-6× area (e)/area (i+i′)). Conversion of PEG (sc)=(1-3×area (a)/area (d+d′)). FIG. 5C illustrates the spacer ratio (rₛₚ) remains nearly constant during the reaction, indicating that NIPAM is randomly distributed along the polymer backbone.

FIGS. 6A-6F illustrate the printability of photocurable bottlebrush PEG resins. FIGS. 6A-6B) illustrate low MW PEG chains dramatically enhance the solubility of N-isopropyl acrylamide (NIPAM) in water. NIPAM is dissolved in (FIG. 6A) water, and (FIG. 6B) a 1:1 (v/v) mixture of water and PEG side chains and left to stay overnight. The solubility of NIPAM in pure water is ˜200 mg in 1 g water. By contrast, in the PEG-water mixture, the solubility significantly increases to 8 g in 1 g mixture. FIG. 6C illustrates the viscosity (n) of PEG-based resins as a function of shear rate (\dot{γ}) for different formulations. The viscosities of pure PEG (green stars) and honey (gray diamonds) are shown for comparison. Regardless of the polymer concentration and the spacer ratios, the viscosity of our PEG-based resins is relatively low and nearly constant across a wide range of shear rates from 1 to 100 s⁻¹, suggesting that resins are low viscosity Newtonian fluids. This is critical to successful DLP 3D printing, which requires the resin to be of relatively low viscosity, so that the resin can easily flow to replenish the space between the printed part and the light source. FIG. 6D illustrates time-dependent evolution of storage (G′) and loss (G″) moduli during UV curing of PEG resins with different spacer ratios (rₛₚ from 0 to 5). Inset: Gelation time, defined as the time beyond which G′ is greater than G″, as a function of space ratio. Regardless of spacer ratios and polymer concentration, even in the melt without water, bottlebrush PEG resins can be photocured rapidly with gelation time less than 5 sec (inset). FIG. 6E illustrates a 3D-printed Menger sponge made from the same cBB PEG resin. Inset: 3D model of the Menger sponge. Scale bar: 1 cm. FIG. 6F illustrates the stress-strain curves of 3D printed, solvent-free elastomers with (green lines) and without (grey lines) spacers, demonstrating enhanced mechanical properties with the introduction of spacer monomers. For each color, different gray scales represent networks of the same formulation but prepared from different batches. Inset: A zoomed-in view of the stress-strain curves at low strains.

FIG. 7A-7F illustrates mechanical and physical properties of cured bottlebrush PEG resins. FIG. 7A illustrates large amplitude oscillatory shear (LAOS) measurements reveal that for the bottlebrush PEG hydrogel with a high spacer ratio (rₛₚ=5), there exists a pronounced strain-softening followed by strain-stiffening, a behavior characteristic of foldable bottlebrush networks.

FIGS. 7B-7D illustrates consecutive cyclic tensile tests of (FIG. 7B) a cBB PEG elastomer and (FIG. 7C) an fBB PEG elastomer reveal that (FIG. 7D) the former exhibits negligible energy dissipation, whereas the latter exhibits pronounced energy dissipation efficiency (>30%) across all strains. For a cBB PEG network (FIG. 7E), in addition to exhibiting a crystallization temperature −36° C., it has a glass transition temperature T_{g} around −67° C. Introducing NIPAM spacer prevents the crystallization of fBB PEG networks but nearly does not alter the T_{g}. However, for the fBB PEG network with a high spacer ratio (rₛₚ=5), although not very obvious, there seems to be a second glass transition temperature (T_{g.2}) around 0° C. FIG. 7F illustrates the existence of T_{g.2} is confirmed by dynamic mechanical analysis (DMA), which reveals that the loss factor, tand=G″/G′, of the network exhibits a pronounced peak at the glass transition temperature (T_{g.2}) associated with the collapsed backbone.

FIGS. 8A-8B illustrate the relative resistance of a bottlebrush PEG ionic elastomer ([2000, 0, 100]+30% LiTFSI) under deformation. FIG. 8A illustrates real-time monitoring of relative resistance, ΔR/R₀, under cyclic tensile test at different strains ranging from 100% to 700%. Here, R₀ is the resistance without deformation and ΔR is the change of resistance under deformation. Under each strain, the value of ΔR/R₀ changes periodically in synchronization with the load-unloading patterns. FIG. 8B illustrates the changes of relative resistance in response to finger-bending angles of 30°, 60°, and 90°.

### DETAILED DESCRIPTION

The present disclosure provides for foldable bottlebrush polymers, foldable bottlebrush polymer networks, method of making foldable bottlebrush polymers and networks, conductive electrolytes including the foldable bottlebrush polymer networks, and the like.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The term “composition” as used herein refers to a product comprising the specified ingredients in the specified amounts, as well as any product which results, directly or indirectly, from combination of the specified ingredients in the specified amounts.

The term “crosslinking” can generally refer to reaction of a portion of the reactive sites of molecules of a polymer to form cross-linking bonds between molecules of the polymer or another polymer.

As used herein, “alkyl” or “alkyl group” refers to a saturated aliphatic hydrocarbon, which can be straight or branched, having 1 to 20, 1 to 10, or 1 to 5 carbon atoms, where the stated range of carbon atoms includes each intervening integer individually, as well as sub-ranges. Examples of alkyl groups include, but are not limited to methyl, ethyl, n-propyl, i-propyl, n-butyl, s-butyl, t-butyl, n-pentyl, and s-pentyl. Reference to “alkyl” or “alkyl group” includes unsubstituted and substituted (e.g., with a halogen) forms of the hydrocarbon moiety.

As used herein, “olefin” is a hydrocarbon that includes at least one double bond. An alpha olefin (α-olefin) has a double bond at the alpha or primary position, whereas an internal olefin includes a double bond within the hydrocarbon chain that is not in the alpha position.

### General Discussion

The present disclosure provides foldable bottlebrush polymers, foldable bottlebrush polymer networks, method of making foldable bottlebrush polymers and networks, electrolytes including foldable bottlebrush polymer networks, batteries including the electrolytes, and the like. The foldable bottlebrush polymers include a backbone including a monofunctional polyethylene glycol unit and a spacer unit, where the combination of units improves the characteristics of the foldable bottlebrush polymer network relative to currently available polymers. The foldable bottlebrush polymer networks of the present disclosure can be used in three-dimensional printing, biomedicine, high-performance lithium batteries, ionotronics, soft robots, stretchable electronics, and advanced (bio) manufacturing.

Polyethylene glycol (PEG) is widely used in basic and translational biomedicine and emerges as solid-state polymer electrolytes for next-generation lithium batteries, yet the additive manufacturing of stretchable PEG polymers has been challenging. The present disclosure provides foldable bottlebrush polymers and networks that are highly stretchable and foldable. The bottlebrush architecture enables high molecular weight PEG network strands that do not crystallize and remain elastic without solvents at room temperature. As described in Example 1, the folded bottlebrush backbone releases stored lengths to enable extreme stretchability. The foldable bottlebrush polymers can be used to create hydrogels and elastomers that can have tissue-mimicking moduli ranging from about 1 to 100 kPa and tensile breaking strains from about 100 to 1500%. In an aspect, the foldable bottlebrush polymers networks are matrices for highly stretchable and conductive solvent-free polymer electrolytes (e.g., about 900% strain and about 1.2 mS/cm) and as resins for printing complex architectures, cytocompatible organ-like geometries, functional devices, and multi-material structures with seamless interface integration. Additional details are provided in Example 1.

While PEG networks are widely used, there are at least two fundamental challenges associated with the development of PEG networks with extreme mechanical properties. As a hydrogel, conventional PEG networks are very brittle because of relatively short network strands, with molecular weight on the order of 10 kg/mols. Without solvent, relatively long PEG chains (>1 kg/mol) inevitably crystallize at room temperature. As a result, solvent-free PEG networks are stiff and brittle. Presently, it is impossible to use linear PEG polymers to create stretchable

The present disclosure provides foldable bottlebrush polymer to create stretchable PEG-based resins for digital light processing (DLP) 3D printing. These PEG networks are formed by rapid photopolymerization of low-cost commercial chemicals in ambient air. The bottlebrush architecture enables high molecular weight PEG network strands that do not crystallize and remain elastic without solvents. Upon large deformations, the folded bottlebrush backbone releases stored lengths to enable extreme stretchability.

The present disclosure allows for the creation of hydrogels and “solvent-free” elastomers with tissue-mimicking moduli ranging from about 1 to 100 kPa and tensile breaking strains up to 1500%, far exceeding existing PEG-based resins. The bottlebrush PEG networks exhibit rapid, full recovery during consecutive cyclic loadings. In addition, the present disclosure provides for applications of bottlebrush PEG networks as matrices for highly stretchable and conductive solvent-free polymer electrolytes (e.g., about 900% strain and about 1.2 mS/cm), as well as resins for DLP printing of complex architectures, cytocompatible organ-like geometries, functional devices, and multi-material structures with seamless interface integration.

Bottlebrush polymers are composed of a polymer chain backbone that has monomer brush units (sidechains or spacers) bonded to the backbone. Bottlebrush polymer networks can include one or more bottlebrush polymer stands, where the polymer strand can crosslink with itself and/or crosslink with other neighboring polymers. When drawn in three dimensions, the brush units resemble the bristles of a brush. Bottlebrush polymer networks are high-density side-chain polymers that have high molecular weights (MWs). Foldable bottlebrush polymer network is designed to collapse on itself (e.g., fold) and can expand and stretch many times their original length. A foldable bottlebrush polymer features a collapsed backbone grafted with many relatively short side chains. If the foldable bottlebrush polymer is in the melt without solvent, the side chains and the backbone should be incompatible the Flory-Huggins interaction parameter χ>0. In solvent, the backbone and the side chains should be different solubility; for instance, the side chains are soluble in the solvent, whereas the backbone does not like the solvent.

The present disclosure provides for compositions that include a foldable bottlebrush polymer network. The foldable bottlebrush polymer network can have one or a combination of characteristics such as a Young's modulus, a tensile breaking strain, a molecular weight, a conductivity, a glass transition temperature, a crystallization point, a spacer/side chain molar ration (rₛₚ), and an average number of side chains per foldable bottlebrush polymer network strand (n_{sc}), that enable the foldable bottlebrush polymers and networks to address and overcome challenges of other polymers.

The foldable bottlebrush polymer network includes at least one strand. The strand can include a polymer backbone that includes a spacer unit and a monofunctional polyethylene glycol (PEG) side chain. In an aspect, the polymer strand can have the following structure:

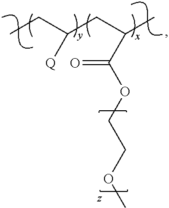

where Q is the spacer and where y is 0 to 10, 1 to 10, 1 to 5, or 0 to 5, x is 50 to 5000 or 100 to 2000, and z is 1 to 200 or 9 to 100. In an aspect, the spacer is N-isopropylacrylamide and can have the following structure:

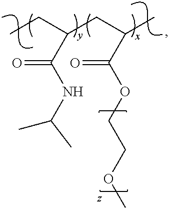

where y is 0 to 10, 1 to 10, 1 to 5, or 0 to 5, x is 50 to 5000 or 100 to 2000, and z is 1 to 100 or 9 to 100.

In an aspect, the spacer unit can be derived from one of the following monomer units. The monomer units can include: N-isopropylacrylamide, vinyl-based unit, olefin-based unit, acrylate-based unit, alkyl acrylate-based unit, acrylamide-based unit, alkyl acrylamide-based unit, allyl (—CH₂HC═CH₂) acrylamide-based unit, urethane-based unit, silane-based unit, siloxane-based unit, styrene-based unit, (maleimide-based units, imide-based units, epoxy-based units, norbornene-based units and derivative of each of these. A monomer corresponding to the monomer unit can be polymerized and the structure of the spacer unit in the polymer will be modified accordingly.

In particular, aspects, the monomer unit can be: Methyl Methacrylate (MMA), Benzyl Methacrylate (BnMA), Ethyl Methacrylate (EMA), Butyl Methacrylate (BMA), Isobutyl Methacrylate (iBMA), Tert-Butyl Methacrylate (tBMA), Hexyl Methacrylate (HMA), Octyl Methacrylate (OMA), 2-Ethylhexyl Methacrylate (EHMA), Lauryl Methacrylate (LMA), Stearyl Methacrylate (SMA), Phenyl Methacrylate (PhMA), Cyclohexyl Methacrylate (CHMA), Methoxyethyl Methacrylate (MEMA), Ethoxyethyl Methacrylate (EEMA), Methoxyethoxyethyl Methacrylate (MEEMA), Hydroxyethyl Methacrylate (HEMA), Hydroxypropyl Methacrylate (HPMA), Dimethylaminoethyl Methacrylate (DMAEMA), Glycidyl Methacrylate (GMA), Vinyl (—C(H)═CH₂) Methacrylate (VMA), Methacrylic Acid (MAA), Perfluorooctyl Methacrylate (PFOMA), Trifluoroethyl Methacrylate (TFEMA), Benzyl Methacrylate (BnMA), Methyl acrylate) (MA), Ethyl Acrylate (EA), Butyl Acrylate (BA), isobutyl acrylate (iBA), tert-butyl acrylate (tBA), hexyl acrylate) (HAA), octyl acrylate (OA), 2-ethylhexyl acrylate) (EHA), dodecyl acrylate (DA), stearyl acrylate (SA), phenyl acrylate (PhA), benzyl acrylate (BzA), Trifluoromethyl Acrylate (TFMA), Perfluorooctyl Acrylate (PFOA), Acrylic Acid (AA), Allyl Acrylate (AA), 2-Hydroxyethyl Acrylate (HEA), 2-Hydroxypropyl Acrylate (HPA), Methoxyethyl Acrylate (MEA), Ethoxyethyl Acrylate (EEA), Methoxyethoxyethyl Acrylate (MEAA), Dimethylaminoethyl Acrylate (DMAEA), Diethylaminoethyl Acrylate (DEAEA), Acrylic Acid (AA), 2-Hydroxyethyl Acrylate (HEA), Hydroxypropyl acrylate (HPA), Methoxyethyl Acrylate (MEA), Ethoxyethyl Acrylate (EEA), Methoxyethoxyethyl Acrylate (MEAA), Dimethylaminoethyl Acrylate (DMAEA), Diethylaminoethyl Acrylate (DEAEA), methyl acrylamide (MAAm), ethyl acrylamide (EAAm), butyl acrylamide (BAAm), isobutyl acrylamide (iBAAm), tert-butyl acrylamide (tBAAm), hexyl acrylamide (HAAm), octyl acrylamide (OAAm), 2-ethylhexyl acrylamide (EHAAm), dodecyl acrylamide (DAAm), stearyl acrylamide (SAAm), phenyl acrylamide (PhAAm), benzyl acrylamide (BzAAm), cyclohexyl acrylamide (CHAAm), methoxyethyl acrylamide (MEAAm), N-isopropylacrylamide (NIPAm), Vinyl Chloride (VC), Styrene(S), Vinylidene Chloride (VDC), Acrylonitrile (AN), Vinylpyrrolidone (VP), Vinylcaprolactam (VCL), Vinyl Ether (VE), Methyl Vinyl Ether (MVE), Ethyl Vinyl Ether (EVE), Butyl Vinyl Ether (BVE), Isobutyl Vinyl Ether (iBVE), Vinyl Acetate (VAc), Isoprene (I), Butadiene (B), Chloroprene (CP), Maleic Anhydride (MAH), Fumaric Acid (FA), Itaconic Acid (IA), Vinyl Ether (VE), Vinyl Ketone (VK), N-Vinylpyrrolidone (NVP), N-Vinylcaprolactam (NVC), Vinylidene Fluoride (VDF), Ethylene (E), Propylene (P), 3-(Trimethoxysilyl) propyl methacrylate (TMSPMA), Methacryloxypropyl-terminated polydimethylsiloxane (PDMS-MA), Hydroxyethyl methacrylate urethane (HEMA-urethane), α-Methylstyrene, N-Phenylmaleimide, Bismaleimide (BMI), Glycidyl methacrylate (GMA), Norbornene methacrylate, Dicyclopentadiene (DCPD), and Allyl glycidyl ether (AGE).

As described above, the foldable bottlebrush polymer network has at least one of the following characteristics within any of the values provided below or herein: a Young's modulus, a tensile breaking strain, a molecular weight, a conductivity, a glass transition temperature, a crystallization point, a spacer/side chain molar ration (rₛₚ), and an average number of side chains per foldable bottlebrush polymer network strand (n_{sc}). The foldable bottlebrush polymer network can have two, three, four, five, six, seven or all of these characteristics within any combination of values provided below or herein.

The foldable bottlebrush polymer network can have a Young's modulus of about 10 Pa to 10 kPa, about 100 Pa to 100 kPa, about 1 to 100 kPa, about 10 to 100 kPa, about 10 to 50 kPa, about 30 to 100 kPa, or about 50 to 100 kPa.

The foldable bottlebrush polymer network can have a tensile breaking strain of 20 to 1500%, about 100 to 1500%, about 400 to 1500%, about 400 to 1200%, about 400 to 1100%, about 400 to 1000%, about 400 to 800%, about 500 to 1500%, about 500 to 1200%, about 500 to 1100%, about 500 to 1000%, about 500 to 800%, about 700 to 1500%, about 700 to 1200%, about 700 to 1100%, about 700 to 1000%, about 700 to 800%, about 800 to 1500%, about 800 to 1200%, about 800 to 1100%, or about 800 to 1000%.

The foldable bottlebrush polymer network can have a molecular weight of about 10 to 10,000 kDa, about 100 to 10,000 kDa, about 1000 to 10,000 kDa, about 2500 to 10,000 kDa, or about 5000 to 10,000 kDa.

The foldable bottlebrush polymer network can have a conductivity of greater than 1 mS/cm, of greater than 1.1 mS/cm, about 1 to 1.4 mS/cm, about 1.1 to 1.3 mS/cm, or about 1.2 mS/cm.

The foldable bottlebrush polymer network can have a glass transition temperature of less than −40° C., of less than −50° C., of less than −60° C., about −60 to −70° C., about −50 to −70° C., or about −40 to −70° C.

The foldable bottlebrush polymer network can have a crystallization point of less than −20° C., of less than −30° C., about −20 to −40° C. or about −30 to −40° C.

The foldable bottlebrush polymer network can have a spacer/side chain molar ration (rₛₚ) of 0 to 5, about 0 to 5, about 1 to 5, about 1 to 4, about 1 to 3, about 2 to 5, or about 3 to 5.

The foldable bottlebrush polymer network can have an average number of side chains per foldable bottlebrush polymer network strand (n_{sc}) of about 10 to 1500, about 20 to 1500, about 50 to 1500, about 20 to 1000, about 50 to 1000, about 100 to 1000, or about 500 to 1000.

In a particular aspect, the foldable bottlebrush polymer network can have a rₛₚ is about 3 to 5, a tensile breaking strain of 1000 to 1500%, and a Young's modulus of about 5 kPa to 15 kPa. In a particular aspect, the foldable bottlebrush polymer network can have a tensile breaking strain of 800 to 1100%, and conductivity of about 1.1 to 1.3 mS/cm.

In an aspect, the present disclosure provides for a conductive electrolyte that includes the composition (e.g., foldable bottlebrush polymer network) of the present disclosure with a lithium salt. In an aspect, the lithium salt can include: lithium perchlorate (LiClO₄), lithium tetrachloroaluminat (LiAlCl₄), lithium iodate (Lil), lithium bromide (LiBr), lithium bis(oxalato) borate (LiB(C₂O₄)₂), lithium bis(oxalato) borate (LiBOB), (LiBF₂ (C₂O₄)), lithium difluoro (oxalato) borate (LiODFB), lithium thiocyanate (LiSCN), lithium tetrafluoroborate (LiBF₄), lithium tetraphenylborate tris(1,2-dimethoxyethane) (LiB(C₆H₅)₄) lithium hexafluoroarsenate (LiAsF₆), lithium triflate (LiCF₃SO₃), LIN (FSO₂)₂, lithium bis(fluorosulfonyl)imide (LiFSI), lithium bis(trifluoromethanesulfonimide) (LiN(CF₃SO₂)₂), lithium bis(trifluoromethanesulfonyl)imide (LiTFSI), lithium hexafluorophosphate (LiPF₆), lithium tetrafluorooxalatophosphate (LiPF₄ (C₂O₄)), lithium tetrafluorooxalatophosphate (LiFOP), lithium nitrate (LiNO₃), and mixtures thereof. The volume of the lithium salt can be about 10 to 40 vol % and the remaining amount can comprise compositions described herein (e.g., foldable bottlebrush polymer network). The conductive electrolyte can be solvent-free and solid state. In an aspect, the conductive electrolyte can also include an ionic liquid. In an aspect, the ionic liquid can include: 1-ethyl-3-methylimidazolium tetrafluoroborate, 1-propyl-3-methylpyrrolidinium bis(trifluoromethylsulfonyl)imide, 1-Ethyl-3-methylimidazolium bis(trifluoromethylsulfonyl)imide, 1-Ethyl-3-methylimidazolium tetrafluoroborate, 1-Butyl-3-methylimidazolium hexafluorophosphate, 1-Butyl-1-methylpyrrolidinium bis(trifluoromethylsulfonyl)imide, N-methyl-N-propylpyrrolidinium bis(fluorosulfonyl)imide, and Triethylsulfonium bis(trifluoromethylsulfonyl)imide. The conductive electrolyte can have a conductivity of greater than 1 mS/cm, of greater than 1.1 mS/cm, about 1 to 1.4 mS/cm, about 1.1 to 1.3 mS/cm, or about 1.2 mS/cm. The conductive electrolyte can be used in a lithium battery.

The present disclosure provides for methods of making a foldable bottlebrush polymer network. The method includes mixing a spacer unit monomer, a monofunctional polyethylene glycol (PEG) side chain monomer, a difunctional PEG crosslinker unit monomer, and a photoinitiator to form a photocurable resin. The photocurable resin is disposed onto a surface, where the surface can be a build substrate or a layer of the composition that was previously disposed and cured. The word “disposed” includes having the photocurable resin (or components that form the photocurable resin) coming into contact with the surface or layer, which can include the photocurable resin being put onto the surface or layer or the surface or layer being put into contact with the photocurable resin. After being disposed on the surface, the photocurable resin can be exposed to ultraviolet energy (e.g., wavelength at 405 nm, from 10-100 mW/cm² for 0.2 to 20 seconds) for a time period (e.g., 5 to 15 seconds) to form a composition including the foldable bottlebrush polymer network. The foldable bottlebrush polymer network can have one or more of the characteristics as described above and herein.

The spacer monomer unit can include those as described above and herein. The monofunctional polyethylene glycol (PEG) side chain monomer can have the following structure:

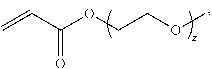

where z is 1 to 200 or 9 to 100. The difunctional PEG crosslinker unit monomer can have the following structure:

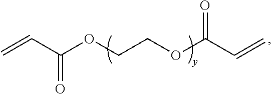

where y is 1 to 400 or 10 to 200. The value of y is greater than value of x, for example by about 1% more, about 2% more, about 5% more, about 10% more, about 20% more, about 40% more, about 100% more, about 200% more, about 500% more (and any combinations of the foregoing amounts defining the low and high % s (e.g., 1 to 500%, 5 to 40%, etc.)), about 1-100% more, about 2-100% more, about 5-100% more, about 10-100% more, about 20-100% more, about 40-100% more, and the like. The difunctional PEG crosslinker unit monomer is longer than the monofunctional polyethylene glycol (PEG) side chain monomer so that there is more space to allow for more efficient crosslinking with neighboring foldable bottlebrush polymers.

In an aspect, the photoinitiator can include a UV photoinitiator such as benzophenones (e.g., benzophenone, methyl benzophenone, Michler's ketone, and xanthones), acylphosphine oxide type free radical initiators (e.g., 2,4,6-trimethylbenzoyldiphenyl phosphine oxide (TMPO), 2,4,6-trimethylbenzoylethoxyphenyl phosphine oxide (TEPO), and bisacylphosphine oxides (BAPO's) such as phenylbis(2,4,6-trimethyl benzoyl) phosphine oxide), azo compounds (e.g., AIBN), benzoins, and benzoin alkyl ethers (e.g., benzoin, benzoin methyl ether and benzoin isopropyl ether)).

In an aspect, a lithium salt, such as those described herein, can be mixed with the spacer unit monomer, the monofunctional polyethylene glycol (PEG) side chain monomer, the difunctional PEG crosslinker unit monomer, and the photoinitiator to produce the conductive electrolyte.

In an aspect, a structure made of the foldable bottlebrush polymer network can be formed by disposing a layer of the composition and curing the composition with UV energy. Then another layer can be disposed on the first layer and the second layer of the composition can be curing with UV energy. This can be repeated to form the desired structure. Alternatively, two or more layers can be cured in a single step. Additional details are provided in Example 1, where the method and system are described.

For example, a 3D-printed structure can be printed using the same foldable bottlebrush polymer network for each layer or two or more types of the foldable bottlebrush polymer network can be used. For example, one layer may be made of a first foldable bottlebrush polymer network and a second layer can be made of a second foldable bottlebrush polymer network. The different types of foldable bottlebrush polymer network can be different types of bottlebrush polymer (chemically different in that different materials (e.g., monomers) are used to create each bottlebrush polymer), can very similar chemically (e.g., the same of similar materials (e.g., same monomers but different amounts) are used to create each bottlebrush polymer) but have one or more different characteristics (e.g., the characteristics that can differ include Young's modulus, tensile breaking strain, molecular weight, the conductivity, the glass transition temperature, the crystallization point, the spacer/side chain molar ratio (rₛₚ), and average number of side chains per foldable bottlebrush polymer network strand (n_{sc})). In an aspect, the layers can be covalently bonded to one another during a single curing step (e.g., for two (or more) layers) so that the layers are seamlessly covalently bonded to one another. Additional features are described in Example 1.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

Polyethylene glycol (PEG) hydrogels are among the most widely used synthetic biomaterials for basic and translational biomedicine. They are used as extracellular matrix (ECM) mimicking materials for probing and controlling cell-matrix interactions (1-4), as systems for delivering therapeutic agents and cells (5-7), and as three-dimensional (3D) cell-instructive scaffolds for tissue engineering (8, 9). Without solvents, PEG networks emerge as solid-state polymer electrolytes for next-generation lithium batteries (10). The application of PEG networks can be greatly expanded by leveraging additive manufacturing, which allows for the rapid fabrication of complex structures with intricate geometric layouts (11-13). For example, 3D printing of photocurable PEG resins via digital light processing (DLP) has produced high-resolution structured gels that can be infused with inorganic salts to create micro-architected metals (14), and hydrogels containing functional biomimetic vascular networks (15).

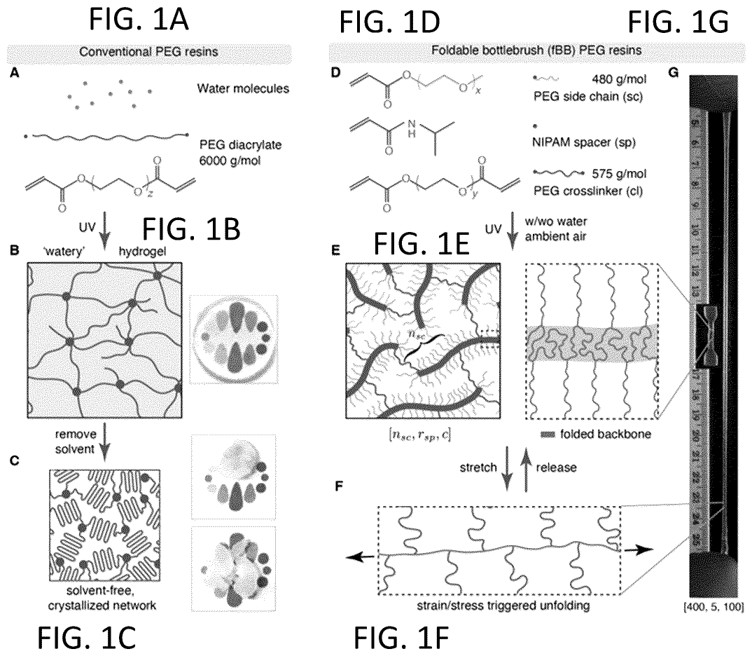

Conventional PEG networks formed by crosslinking linear PEG polymers are intrinsically brittle. In the presence of solvent, PEG gels exhibit low stretchability because of inhomogeneous, short network strand sizes. Under large deformations, stress tends to concentrate along relatively short network strands, causing premature network failure. Using mobile crosslinks, either entanglements (16) or slide-rings (17), helps redistribute stress throughout the network and dramatically improve stretchability. However, these methods often require multiple-step processing or chemical synthesis that is unsuitable for three-dimensional (3D) printing. In the dry state, linear PEG polymers tend to crystallize starting at a relatively low molecular weight (MW) (˜1,000 g/mol) (18), making conventional linear PEG networks stiff and brittle (FIG. 1A-C). Thus, it remains a fundamental challenge in the development of 3D printable stretchable PEG networks.

### Results

### Design of 3D Printable Modular Stretchable Bottlebrush PEG Networks

Unlike a linear polymer, a bottlebrush polymer consists of a linear backbone densely grafted with many relatively short side chains. It is possible to use low MW PEG side chains to create bottlebrush PEG polymers that have high MWs but remain elastic without solvent. However, the highly overlapped side chains generate strong steric repulsion that pre-strains the bottlebrush backbone (19-21), resulting in brittle polymer networks (22-27). Recently, we discovered an unexpected folding of bottlebrush polymers in the melt. For a bottlebrush polymer with incompatible backbone and side chains, despite the strong steric repulsion among the overlapping side chains, the backbone collapses into a cylindrical core with all grafting sites on its surface to reduce interfacial free energy (28, 29). This foldable bottlebrush polymer stores lengths that can be released upon large deformations, enabling extremely stretchable polymer networks (30). In our proof-of-concept work, this strategy has been realized only in poly(dimethyl siloxane) (PDMS) based elastomers through sophisticated multistep chemical synthesis (30).

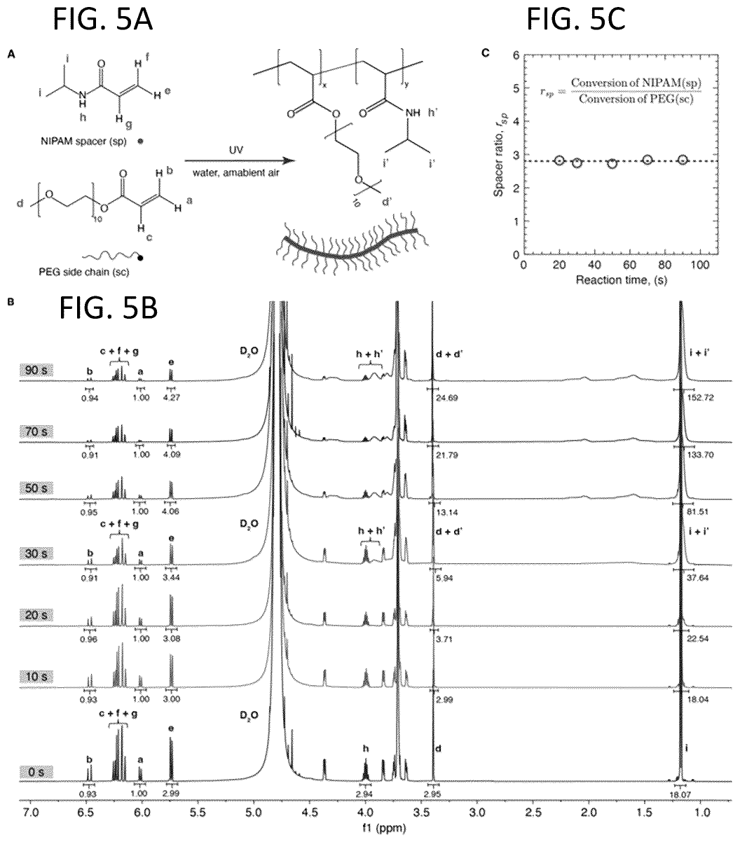

Here, we exploit the foldable bottlebrush polymer concept to create stretchable PEG-based resins for DLP 3D printing. The resin consists of three commercially available, low-cost precursors: monofunctional low MW PEG (PEG methyl ether acrylate, 480 g/mol) as side chains, N-isopropyl acrylamide (NIPAM) as spacer monomers, and difunctional low MW PEG (PEG diacrylate, 575 g/mol) as crosslinking chains (FIG. 1D). The crosslinking chain is slightly larger than the side chain to allow efficient crosslinking of neighboring bottlebrush polymers. These three monomers form a randomly crosslinked bottlebrush network via ultra-violet (UV) triggered free radical polymerization in ambient air (FIGS. 5A-5C). Because PEG is highly soluble in water but not NIPAM, the NIPAM-based backbone collapses to store lengths that can be released under large deformation, resulting in stretchable PEG networks (FIG. 1E-G).

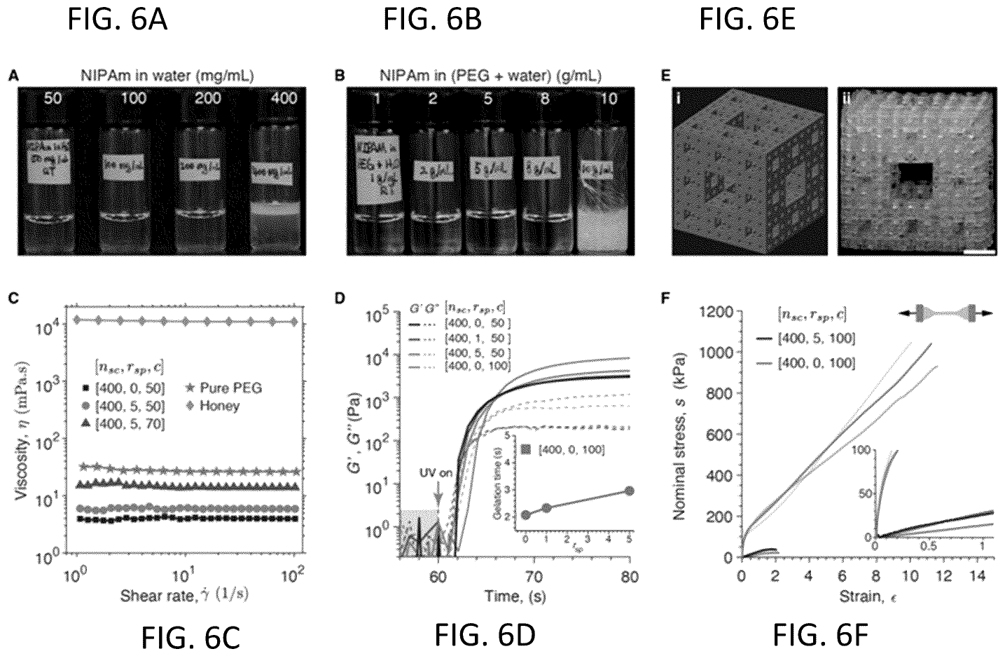

The fBB PEG resins allow for modular control over network molecular architecture. For instance, the average number of side chains per network strand, n_{sc}, equals the side chain to crosslinking chain molar ratio. The grafting density of side chains is determined by the spacer to side chain molar ratio, rₛₚ. Further, despite the low solubility of NIPAM monomers in water (˜0.2 g NIPAM per 1 g water, FIG. 6A), the precursor PEG side chains help dissolve NIPAM up to a very high concentration (>8 g NIPAM in 1 g water, FIG. 6B) without substantially increasing the resin viscosity (FIG. 6C). As such, the polymer concentration, c, can be adjusted in a wide range while allowing the resin to be printable, even in the melt without water (FIG. 6D-F). Consequently, the mechanical properties of fBB PEG resins can be encoded into three design parameters, [n_{sc}, rₛₚ, c].

### Bottlebrush PEG Hydrogels

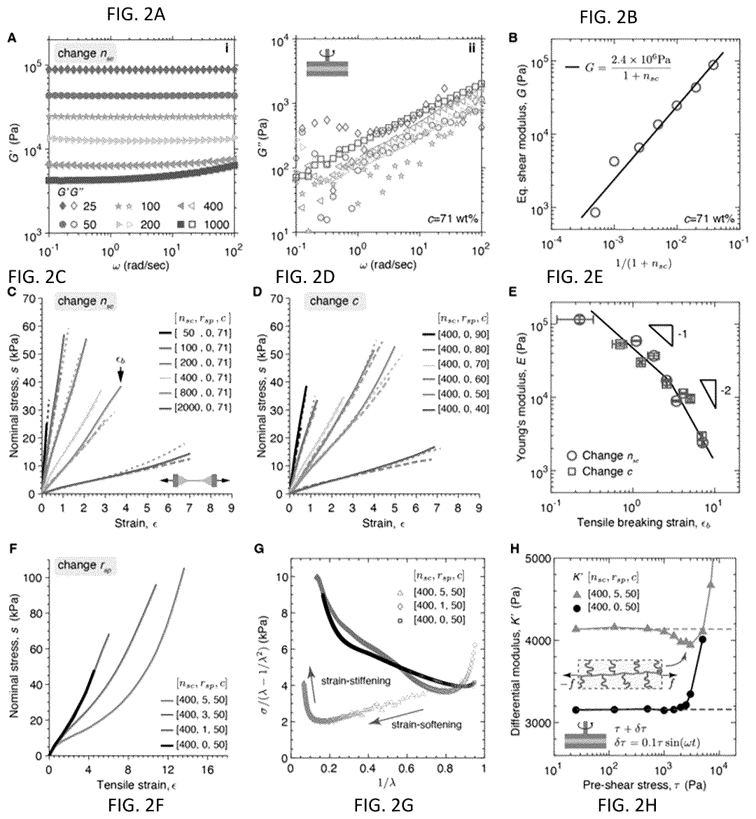

To determine the roles of each design parameter in the network mechanical properties, we begin with conventional bottlebrush (cBB) PEG hydrogels without spacer monomers (rₛₚ=0). We fix the polymer concentration at c=71 wt % and change the number of side chains from 25 to 2000, corresponding to an average network strand MW from ˜ 12 kg/mol to ˜1,000 kg/mol ([25-2000, 0, 71]). Regardless of the network strand MW, all hydrogels are elastic solids with nearly constant shear storage modulus G′ over a wide range of shear frequencies (FIG. 2A). Thus, we take the value of G′ at the lowest frequency, 0.1 rad/sec, as the equilibrium shear modulus, G, of the hydrogel. For all hydrogels, the values of G are lower than the plateau modulus of entangled long linear polyethylene oxide (PEO), Gₑ(ϕ)≈Gₑ(1) ϕ^{2.3}≈800 kPa, in which Gₑ(1)≈1.8 MPa the entanglement modulus of PEO melt and ϕ≈0.71 is polymer volume fraction (31). Moreover, G increases linearly with the number concentration of crosslinking chains, 1/(n_{sc}+1), following the relation: G=2.4×10⁶ Pa/(n_{sc}+1) (FIG. 2B). Notably, the hydrogel stiffnesses cover those of various soft biological tissues (1-100 kPa), including the relatively stiff tendon (32).

Like classical linear PEG hydrogels, the stretchability of cBB PEG hydrogels negatively correlates with stiffness (FIG. 2C). However, because the bottlebrush architecture allows for network strands with extremely high MW, the stretchability of cBB PEG hydrogels can be tuned across a wide range. As the number of side chains per network strand increases by 40-fold (n_{sc} from 50 to 2000), the tensile breaking strain (ϵ_{b}) increases by nearly 35-fold, from 20% to 700% (FIG. 2C). By contrast, linear PEG hydrogels formed by crosslinking tetra-arm PEG polymers exhibit an upper limit in tensile breaking strain of ˜300% (17). Moreover, for all cBB PEG hydrogels, the nominal stress(s) increases nearly linearly with strain (ϵ) until failure (FIG. 2C). These results demonstrate that using bottlebrush PEG polymers as network strands enables modular, stretchable, biomimetic hydrogels.

The mechanical properties of cBB PEG hydrogels can also be tuned by changing polymer concentration. By fixing the number of side chains at a moderate value (n_{sc}=400) and decreasing the polymer concentration from 90 to 40 wt %, the hydrogel Young's modulus (E) decreases by nearly 25-fold, from ˜20 kPa to ˜800 Pa. Simultaneously, the hydrogels become much more stretchable with E, increased by 9-fold, from 80% to 720% (FIG. 2D).

Interestingly, for both series of hydrogels (changing n_{sc} or c), the stiffness-extensibility correlation (E vs ϵ_{b}) collapses onto a universal curve. This relationship features two distinct regimes: E∝(ϵ_{b})^{-α}, where α=1 for relatively stiff, brittle hydrogels and α=2 for relatively soft, stretchable hydrogels (FIG. 2E). At the crossover between these two regimes, the network Young's modulus is ˜30 kPa, corresponding to a network mesh size of aₓ≈(3k_{B}T/E)^{1/3}≈8 nm, where k_{B} is the Boltzmann constant and T=293 K is the absolute temperature. The network mesh size is about twice the persistence length (4 nm) of the bottlebrush PEG polymer in water (33-37); this indicates that the network strand behaves as a semiflexible bottlebrush polymer (26). The transition of a from 1 to 2 as the network strand shifts from flexible to semiflexible bottlebrush molecules is consistent with the existing understanding of randomly crosslinked bottlebrush polymer networks (24).

Next, we explore the effects of NIPAM spacers on the mechanical properties of hydrogels. Based on a hydrogel formulation ([400, 0, 50]) with a balanced stiffness and stretchability (E˜10 kPa, ϵ_{b}˜400%) (black line, FIG. 2F), we increase the spacer ratio up to 5, at which the average MW of the spacer segment is comparable to the PEG side chain. This ensures that the composition of the network strand is dominated by the side chains rather than the backbone. To determine whether introducing NIPAM spacers results in fBB networks, we characterize the mechanical properties of hydrogels under large deformations. At a small spacer ratio (rₛₚ=1), the stress-strain curve is nearly identical to the control network (rₛₚ=0), except for a higher tensile breaking strain of 600% (dark blue line, FIG. 2F). By contrast, at relatively high spacer ratios (rₛₚ≥3), the hydrogels exhibit nonlinear elasticity with delayed stiffening (light blue and orange lines, FIG. 2G). This behavior is further confirmed by plotting the Mooney-Rivlin stress (31, 38), s/(λ−1/λ²), against 1/λ, where λ=ϵ+1 represents the extent of elongation. This plot reveals pronounced strain-softening followed by strain-stiffening (FIG. 2G).

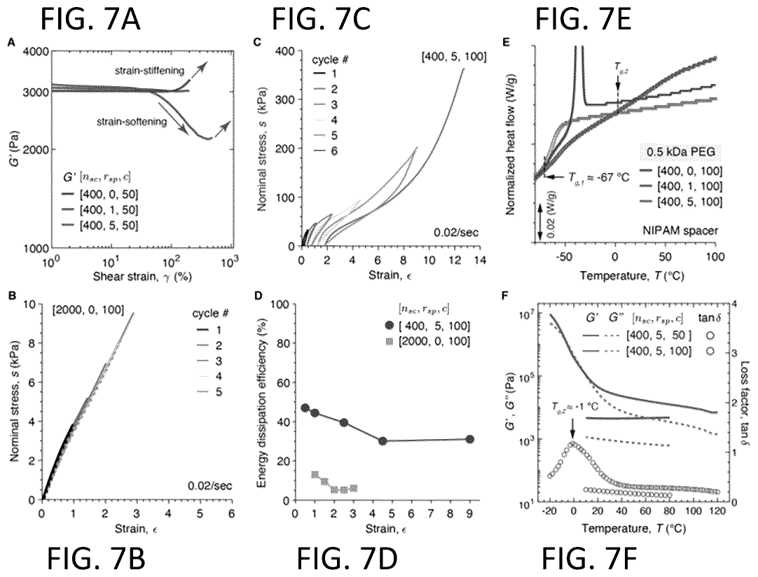

To further explore the nonlinear elasticity of hydrogels with spacers, we perform prestress measurements (39) to probe their mechanical properties under different stresses. For each sample, we apply a steady shear stress with a magnitude τ, superimposing a small amplitude stress oscillation of amplitude δτ=0.1τ and frequency 1 rad/sec. The storage modulus at each steady shear stress is defined as the differential modulus, K′(τ)=δτ/δγ, where γ is the shear strain. When the hydrogels are subjected to steady shear stress, K′ is nearly constant at low stress, reflecting linear elasticity. For the control hydrogel without spacers, K′ increases dramatically at high stress (solid circles, FIG. 2H). This stress-stiffening behavior is attributed to extending the network strand to its stretching limit. Remarkably, for the hydrogel with the highest spacer ratio (rₛₚ=5), K′ decreases substantially at intermediate stress, followed by a rapid increase at high stress (triangles, FIG. 2H). Consistent with prestress measurements, large amplitude oscillatory shear (LAOS) measurements reveal remarkable strain-softening followed by stain-stiffening (FIG. 7A). The delayed stress/strain stiffening, following stress/strain softening, is characteristic of foldable bottlebrush networks (30). At intermediate strains or stresses, the network strand unfolds and becomes unable to sustain stress efficiently, resulting in stress/strain-softening. At high stresses, the unfolded backbone is extended toward its stretching limit, resulting in stress/strain-stiffening. These results indicate that introducing NIPAM spacer monomers enables fBB PEG hydrogels.

The fBB PEG hydrogels are extremely stretchable. For instance, at rₛₚ=3, the tensible breaking strain ([400, 3, 50], ϵ_{b}˜1000%) is much higher than the cBB hydrogels, even those with larger bottlebrush backbone contour lengths ([2000, 0, 71], ϵ_{b}=720%). As rₛₚ increases from 0 to 5, ϵ_{b} increases by nearly four times from 400% to 1400% (FIG. 2F). This remarkable stretchability is comparable to that of slide-ring PEG hydrogels, which represent the most stretchable PEG hydrogels in literature but require sophisticated multistep synthesis (17). Regardless of the spacer ratios, the Young's moduli of the fBB PEG hydrogels remain nearly constant at ˜10 kPa. This is because the stiffness of the hydrogel is proportional to the number concentration of network strands, which does not change with the spacer ratio. These findings demonstrate that fBB PEG hydrogels enable modular, independent control over stiffness and extensibility.

### Bottlebrush PEG Elastomers

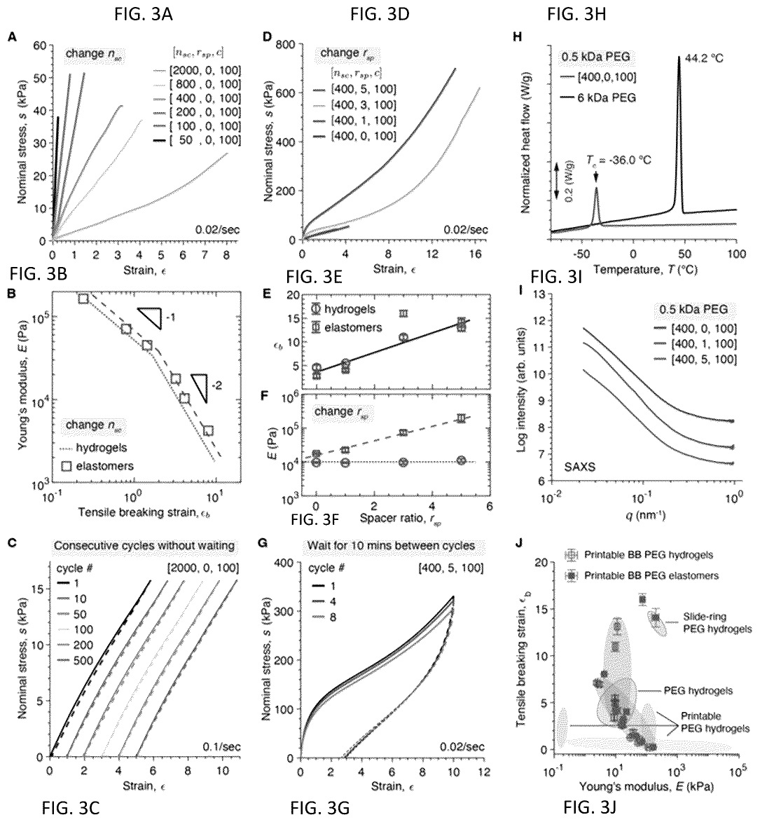

Unlike linear PEG networks that become stiff and brittle in the dry state, bottlebrush PEG networks remain elastic regardless of the network strand size (FIG. 3A). Since removing solvent does not alter the network topology, the stiffness-extensibility correlation of cBB PEG elastomers is qualitatively the same as that of hydrogels, which exhibit two regimes depending on stiffness (FIG. 3B). However, since removing solvent de-swells the network strand and increases the crosslink concentration, the solvent-free networks are slightly stiffer and more stretchable than their hydrogel counterparts (dotted line, FIG. 3B).

A key feature of cBB PEG elastomers is their negligible mechanical hysteresis. For instance, even the softest elastomer explored here ([2000, 0, 100], E˜3 kPa) shows nearly no residual strain upon cyclic loading at various strains (FIG. 7B). This mechanical reversibility is further validated over 500 consecutive loading-unloading cycles at up to 500% strain (FIG. 3C).

Removing solvents from fBB PEG hydrogels does not impair their stretchability but increases their modulus (FIG. 3D-F). As the spacer ratio increases from 0 to 5, E increases over 10-fold, from ˜17 kPa to ˜200 kPa, following an exponential trend (solid line, FIG. 3E). This exponential increase aligns with our previous findings for fBB PDMS elastomers (30). It is likely attributed to the NIPAM spacers, which have a high glass transition temperature when forming a polymer (T_{g}˜135° C.) (40). As a result, the fBB network strand itself becomes stiff in the dry state at room temperature (RT).

When subjected to loading and unloading, the backbone of an fBB PEG network strand undergoes an unfolding-folding process. This deformation is reversible but takes time, as demonstrated by the full recovery of a stretched sample after 10 minutes (FIG. 3G). During consecutive loading-unloading, the fBB PEG elastomer ([2000, 0, 100]) exhibits pronounced hysteresis and has energy dissipation efficiency of ˜30% across various strains up to fracture (FIG. 7C, D). These results suggest that fBB PEG elastomers allow for concurrent enhancement of stiffness, stretchability, and energy dissipation, which is critical for the development of tough polymeric materials.

To understand the molecular origin of the high stretchability of bottlebrush PEG elastomers, we quantify their crystallization temperature (T_{c}) and glass transition temperature (T_{g}) using differential scanning calorimetry (DSC). For a conventional linear PEG network (FIG. 1A-C), the T_{c} is 44.2° C., well above RT (black line, FIG. 3H). By contrast, for a cBB PEG network ([400, 1 100]), the T_{c} is −36.0° C., well below RT (red line, FIG. 3H). Introducing NIPAM spacers prevents the crystallization of fBB PEG networks (FIG. 7E), indicating that bottlebrush PEG networks are amorphous in the dry state. This is further confirmed by the absence of characteristic peaks from small-angle X-ray scattering (SAXS) (FIG. 3I). Moreover, all networks have T_{g} below RT (FIG. 7E). Collectively, our results demonstrate that the bottlebrush molecular architecture prevents crystallization of high MW PEG polymers at RT, enabling highly stretchable PEG elastomers.

### Applications of Bottlebrush PEG Networks

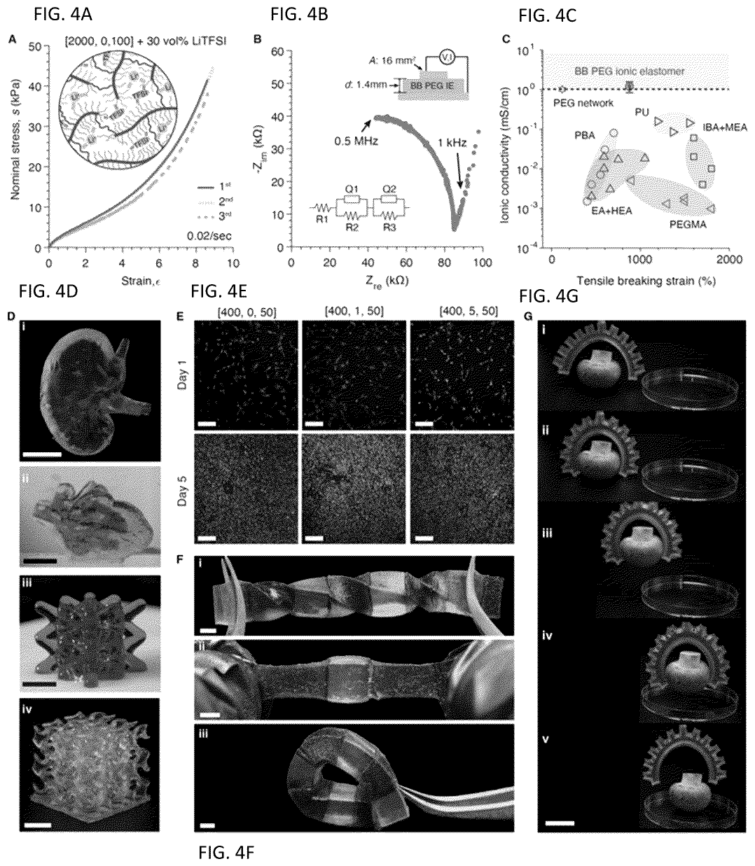

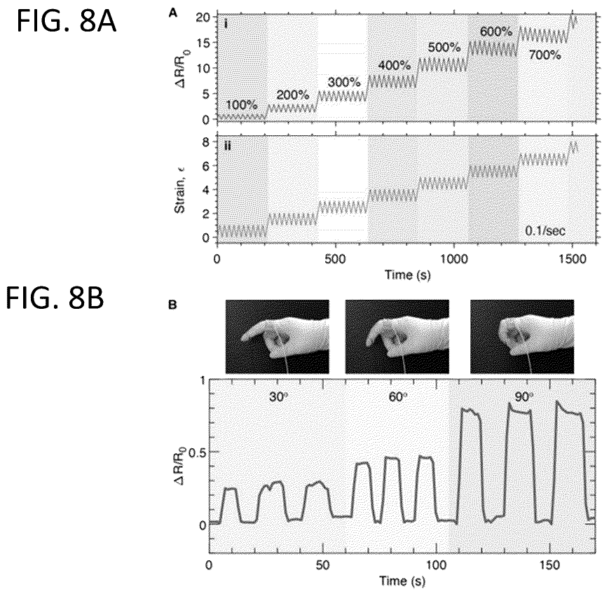

Bottlebrush PEG networks are far more stretchable than existing PEG hydrogels (FIG. 3J) (12, 17, 41-43). Such superior mechanical performance enables many practical applications. For instance, bottlebrush PEG elastomers can be applied as matrices for high-performance solid-state polymer electrolytes, which are crucial to the next-generation lithium-based batteries with high energy density and improved safety (44). In one example, we dissolve 30 vol % bis[(trifluoromethyl)sulfonyl]imide lithium (LiTFSI) salt into a cBB PEG resin ([2000, 0, 100]) without any solvent. This results in an ionic elastomer with an exceptional combination of stretchability (ϵ_{b}˜900%, FIG. 4A) and high conductivity (1.2 mS/cm, FIG. 4B), outperforming existing solvent-free polymer electrolytes (FIG. 4C) (45-50). Because the bottlebrush PEG ionic elastomer can be repeatedly stretched at various strains without hysteresis, it can be readily used as a stretchable sensor (FIG. 8)

The photocurable bottlebrush PEG hydrogels and elastomers can be readily used as resins for DLP printing, enabling the fabrication of free-standing, organ-like geometries with intricate internal structures and complex structures (FIG. 4D). Moreover, the bottlebrush PEG resins are cytocompatible (FIG. 4E), highlighting their potential in advanced biomanufacturing (15). Under solvent-free conditions, the stiffness of fBB PEG networks can be widely tuned by adjusting the spacer monomers. Despite different spacer ratios, all resins are cured using the same chemistry, enabling networks of contrasting mechanical properties to be seamlessly integrated at the molecular level. This feature makes the resins ideal for multilateral printing (51) of composites with seamless soft-hard interfaces. For example, a printed one-dimensional strip consisting of alternating soft ([400, 0, 100], E˜17 kPa) and stiff ([400, 5, 100], E˜200 kPa) resins can be twisted, bent, and stretched by a large extent without interface failure (FIG. 4F). Additionally, the soft, stretchable bottlebrush PEG elastomeric resin can be transformed into a pneumatic gripper that operates effectively under compressed air at a relatively low pressure of 20 kPa (FIG. 4G).

### Discussion

We have discovered that bottlebrush molecular architecture prevents the crystallization of high MW PEG polymers, enabling highly stretchable photocurable hydrogels and elastomers for high-performance conductive solvent-free electrolytes and additive manufacturing of complex structures. The bottlebrush PEG resins are based solely on commercially available precursors. These resins are of low viscosity and can be rapidly photocured in ambient air regardless of solvents, such that they can be readily used for DLP printing. The stretchability of bottlebrush PEG hydrogels described here (e_{b}=720%) substantially exceeds that of existing PEG-based resins (e_{b}<430%). Moreover, introducing NIPAM spacers results in foldable bottlebrush PEG hydrogels, which exhibit a remarkable stretchability (e_{b}=1400%) that is comparable to that of slide-ring gels (17). However, unlike slide-ring gels that rely on sophisticated multiple syntheses, foldable bottlebrush PEG hydrogels can be easily fabricated through a one-step process. In the dry state, the bottlebrush PEG networks remain elastic and stretchable (ep up to 1500%); this is in remarkable contrast to conventional linear PEG networks, which inevitability crystallize and become very brittle without solvents.

The bottlebrush PEG networks can be used as matrices for highly stretchable and conductive solvent-free polymer electrolytes (˜900% strain and 1.2 mS/cm) and as resins for printing complex architectures, cytocompatible organ-like geometries, functional devices, and multi-material structures with seamless interface integration. Yet, these demonstrations illustrate only a few of the many potential applications of stretchable PEG hydrogels. For instance, the PEG side chains can be functionalized to impart tissue-specific biochemical properties (4, 9, 52) without compromising the physical properties of the networks. Replacing water with ionic liquids may lead to stretchable, nondispersive ionic gels (53). The developed 3D printable, modular, stretchable bottlebrush PEG resins will dramatically expand the already vast applications of PEG networks, particularly in biomedicine, and provide a versatile platform material for high-performance lithium batteries (10), ionotronics (54), soft robots (55), stretchable electronics (56), and advanced (bio) manufacturing.

### 1. Materials and Methods

### 1. Materials

Polyethylene glycol methyl ether acrylate (mPEG-AC, 480 g/mol), polyethylene glycol diacrylate (PEGDA, 575 g/mol), N-isopropylacrylamide (NIPAM, 113 g/mol), lithium phenyl-2,4,6-trimethylbenzoylphosphinate (LAP), and phenylbis(2,4,6-trimethyl benzoyl) phosphine oxide (BAPO) are purchased from Sigma-Aldrich. Lithium bis(trifluoromethanesulfonyl)imide (LiTFSI) is purchased from TCI America. All chemicals are used without purification. Deionized (DI) water is used for all experiments except for the cytocompatibility test.

### 2. Fabrication of Hydrogels and Elastomers

### 2.1. Molded Samples

In general, mPEG-AC, PEGDA, NIPAM, and LAP are mixed in water to form a colorless, optically transparent, low-viscosity precursor solution. The amount of photoinitiator relative to the monomer content is fixed at 0.5 wt %. We present a detailed fabrication procedure using a sample, [400, 5, 50], as an illustrative example.

To prepare the sample [400, 5, 50], we add mPEG-AC (2 g, 4.2 mmol), PEGDA (6 mg, 0.01 mmol), NIPAM (2.4 g, 21 mmol), and LAP (22 mg) in water (4.4 ml). The reaction mixture is then ultra-sonicated for 30 min to form a homogeneous solution, which is poured into a Teflon mold and covered with a glass slide to prevent water evaporation. The solution is cured for 30 minutes in a UV box (405 nm at 40 mW/cm²) at RT to form a hydrogel. To make a solvent-free polymer network, the hydrogel is placed in a hot oven at 80° C. overnight and then in a vacuum oven at room temperature overnight. We confirm that drying for longer does not reduce the sample mass to ensure that the network is solvent-free.

### 2.2. 3D Printed Samples

We take one sample, [400, 5, 70], as an example to illustrate the printing process. The photocurable resin is prepared by mixing 7.2 g of mPEG-AC, 0.0216 g of PEGDA, 8.52 g of NIPAM, 0.036 g of LAP (0.5 wt %), and 0.01 g of tartrazine (0.1 wt %) in 6 ml water. We use tartrazine as a photo absorber, which reduces light scattering and thus helps enhance printing quality. This mixture is stirred vigorously for 40 minutes and then degassed to form a homogeneous solution.

DLP 3D printing is performed using a customized system that includes a Wintech PRO6500 UV Projector (385 nm), a Zaber X-LSQ150A linear stage, and a Sovol resin vat with a clear fluorinated ethylene propylene (FEP) window (57). The printing parameters are set to a layer thickness of 100 μm and a UV irradiance of 17 mW/cm². The first layer is exposed to UV light for 12 seconds to ensure proper adhesion to the build plate, while the subsequent layers are exposed for 6 seconds each. After printing, the parts are washed with isopropanol and then further cured in a Formlabs Form Cure system at 70° C. for 3 hours.

### 2.3. Ionic Elastomer Samples

We prepare a bottlebrush PEG-based ionic elastomer using a polymer matrix formulation of [2000, 0, 100] and LiTFSI as the lithium salt. Specifically, we mix mPEG-AC (2 g, 4.2 mmol), PEGDA (1.2 mg, 0.002 mmol), and BAPO (4 mg, 0.2 wt %) in a vial. The mixture is then ultrasonicated for 30 min to form a homogeneous solution. Subsequently, LiTFSI (1 g, 30 vol %) is added to the mixture. The mixture with lithium salt is mixed using a vortex mixer for 5 min and placed in an oven at 50° C. overnight to ensure the complete dissolution of the lithium salt. Then, the solution is poured into a Teflon mold and cured for 2 min in the UV box at room temperature to form an ionic elastomer.

### 3. Tensile Tests

We use Instron (Model No. 5966) with a 10 N load cell to measure the mechanical properties of the hydrogels and elastomers. The samples are prepared as described above and cut into dumbbell shapes with a central part of 13 mm in length, 3 mm in width, and 1.5-2.0 mm in thickness. Uniaxial tensile tests are performed in ambient air at a fixed strain rate of 0.02/sec. Nominal stress is calculated as the tensile force per unit of the initial cross-section area of the central part. During the tensile test, we use a camera to record the strain by tracking the displacement of the central part of a dumbbell-shaped sample. For cyclic tensile tests, the same setup and conditions are used.

### 4. Rheological Characterization

Rheological measurements are performed using a stress-controlled rheometer (MCR 302, Anton Paar) equipped with a plate-plate geometry of 25 mm in diameter and a UV irradiator. Approximately 0.25 mL of the solution is pipetted onto the bottom plate of the rheometer. Then, we lower the upper plate to allow the solution to fill the gap with a fixed distance of 0.5 mm.

To quantify the curing kinetics, we monitor the dependence of shear and loss moduli on time at a fixed strain of 0.5% and a frequency of 1 rad/s. We wait for 1 min to allow the measurements to be stable and then apply UV irradiation (405 nm, 5 mW/cm²) until complete crosslinking. For frequency sweep, we fix the temperature at 20° C. and the oscillatory shear strain at 0.5% while varying the shear frequency from 0.1 rad/sec to 100 rad/sec. For strain sweep, we fix the temperature at 20° C. and the oscillatory frequency at 1 rad/sec while increasing the shear strain from 1% to 1000%.

For pre-stress tests, a low amplitude oscillatory stress δτ=0.1τ is superposed to a constantly applied pre-stress t, and the differential elastic modulus, K′(τ)=[δτ/δγ]_{T}, is determined as a function of τ at 1 Hz. The first applied constant stress is 1 Pa in amplitude. Subsequent pre-stresses are 5, 25, 125, and so on. At each interval of applied constant stress, small deformation oscillations (0.1τ) are conducted at frequencies ranging from 0.1 Hz to 10 Hz for 5 min to reach stable measurements. Finally, the differential elastic modulus at 1 Hz versus the applied constant stress is obtained.

### 5. Cytocompatibility Test

NIH-3T3 cells (ATCC) are cultured in Dulbecco's Modified Eagle Medium (DMEM) with 10% fetal bovine serum (FBS) and 1% penicillin-streptomycin. The cells are incubated in T75 flasks at 37° C. with 5% CO₂. When they reach confluence, the cells are detached using a trypsin-EDTA solution.

To prepare the experimental groups, PEG hydrogels with spacers ([400, 5, 50]) and without spacers ([400, 0, 50]) are soaked in phosphate-buffered saline (PBS) overnight to remove unreacted monomers if any, then equilibrated in DMEM. Two kinds of culture medium are prepared: DMEM only (control) and DMEM extracts from each PEG hydrogel group. Cells are seeded at a density of 1×10⁵ cells per well in 12-well plates, with at least 5 duplicate wells for each condition. After an overnight incubation to allow cell attachment, the culture medium is replaced at 24 hours and subsequently every 48 hours.

Cell viability is assessed every 24 hours using a dual staining method with fluorescein diacetate (FDA) and propidium iodide (PI). 1 ml staining solution containing 0.5 M FDA and 5 μM PI is added to each well and incubated at room temperature for 5 minutes in the dark.

Fluorescence images are captured from two randomly selected fields per well using a fluorescence confocal microscope (Leica SP8) with filters for FDA (green, excitation/emission: 500/540 nm) and PI (red, excitation/emission: 600/700 nm). This imaging is performed daily, yielding four images per condition per day. The number of live (FDA-positive) and dead (PI-positive) cells is counted using ImageJ (NIH), and cell viability is calculated as the percentage of live cells relative to the total cell count. Statistical analysis is performed using one-way analysis of variance (ANOVA), followed by Tukey's Honest Significant Difference (HSD) test to assess the significance of differences across the three test groups throughout the 5-day experimental timeline. The impact of varying PEG polymer concentrations on 3T3 cell viability was evaluated, with statistical significance defined as p<0.05.

### 6. Ionic Conductivity Measurement

Electrochemical Impedance Spectroscopy (EIS) is used to determine bulk electrolyte properties of an ionic elastomer. The test is performed using a Keysight E4980A LCR Meter with copper electrodes. The elastomer sample has a thickness of 1.4 mm, and the top copper electrodes have a contact area of 0.16 mm². The measurement voltage is set to 10 mV, and frequency sweeps are performed from 20 Hz to 0.5 MHz. The ionic conductivity (σ) of the elastomer is calculated using the equation σ=L/(R·A), where L represents the thickness of the elastomer, A denotes the contact area between the elastomer and the electrodes, and R is the bulk resistance.

For the relative resistance change test at various tensile strains, the ionic elastomer is cut into a dumbbell shape, and aluminum plates are attached to the middle gauge section of the sample to serve as electrodes. The sample is then loaded to the Instron with a 10 N load cell. Resistance changes corresponding to uniaxial tensile strain are measured under a tensile strain rate of 0.1/s.

### 7. ¹H NMR Characterization

Proton nuclear magnetic resonance (¹H NMR) spectroscopy is performed using Varian NMRS 600 MHz spectrometer. For all samples, deuterated water (D₂O) is used as a solvent.

### 8. Differential Scanning Calorimetry

We measure the physical properties of solvent-free PEG networks using a temperature modulated differential scanning calorimeter (DSC250, TA Instruments). Before characterization, the samples are further dried at RT (˜293 K) under vacuum (30 mbar) for at least 24 hours. A standard aluminum DSC pan is used for all the measurements with approximately 10 mg of sample loaded. All the samples were annealed at 423 K for 3 min to erase the thermal history, followed by cooling at 2 K/min to 183 K with a modulation amplitude of ±1 K/min and a modulation frequency of 60 Hz. The T_{g} values are determined as the midpoint of the normalized heat flow jump; these values are also consistent with those determined by the inflection point of the heat flow under temperature sweep.

### REFERENCES

1. S. Nam, R. Stowers, J. Lou, Y. Xia, O. Chaudhuri, Varying PEG density to control stress relaxation in alginate-PEG hydrogels for 3D cell culture studies. Biomaterials. 200, 15-24 (2019).
2. A. Saraswathibhatla, D. Indana, O. Chaudhuri, Cell-extracellular matrix mechanotransduction in 3D. Nat Rev Mol Cell Biol. 24, 495-516 (2023).
3. G. P. Raeber, M. P. Lutolf, J. A. Hubbell, Molecularly engineered PEG hydrogels: A novel model system for proteolytically mediated cell migration. Biophys J. 89, 1374-1388 (2005).
4. J. L. West, J. A. Hubbell, Polymeric biomaterials with degradation sites for proteases involved in cell migration. Macromolecules. 32, 241-244 (1999).
5. C. C. Lin, K. S. Anseth, PEG hydrogels for the controlled release of biomolecules in regenerative medicine. Pharm Res. 26, 631-643 (2009).
6. N. A. Peppas, K. B. Keys, M. Torres-lugo, A. M. Lowman, Poly (ethylene glycol)-containing hydrogels in drug delivery. 62, 81-87 (1999).
7. J. A. Burdick, K. S. Anseth, Photoencapsulation of osteoblasts in injectable RGD-modified PEG hydrogels for bone tissue engineering. Biomaterials. 23, 4315-4323 (2002).
8. J. L. Drury, D. J. Mooney, Hydrogels for tissue engineering: Scaffold design variables and applications. Biomaterials. 24, 4337-4351 (2003).
9. J. Zhu, Bioactive modification of poly(ethylene glycol) hydrogels for tissue engineering. Biomaterials. 31, 4639-4656 (2010).
10. S. Choudhury, S. Stalin, D. Vu, A. Warren, Y. Deng, P. Biswal, L. A. Archer, Solid-state polymer electrolytes for high-performance lithium metal batteries. Nat Commun. 10, 1-8 (2019).
11. V. Chan, P. Zorlutuna, J. H. Jeong, H. Kong, R. Bashir, Three-dimensional photopatterning of hydrogels using stereolithography for long-term cell encapsulation. Lab Chip. 10, 2062-2070 (2010).
12. S. N. Anindita, R. Conti, D. Zauchner, N. Paunović, W. Qiu, M. G. Buzhor, A. Krivitsky, Z. Luo, R. Müller, H. Grützmacher, X. H. Qin, J. C. Leroux, Y. Bao, Tough PEG-only hydrogels with complex 3D structure enabled by digital light processing of “all-PEG” resins. Aggregate. 4, 1-14 (2023).
13. A. Urrios, C. Parra-Cabrera, N. Bhattacharjee, A. M. Gonzalez-Suarez, L. G. Rigat-Brugarolas, U. Nallapatti, J. Samitier, C. A. Deforest, F. Posas, J. L. Garcia-Cordero, A. Folch, 3D-printing of transparent bio-microfluidic devices in PEG-DA. Lab Chip. 16, 2287-2294 (2016).
14. M. A. Saccone, R. A. Gallivan, K. Narita, D. W. Yee, J. R. Greer, Additive manufacturing of micro-architected metals via hydrogel infusion. Nature. 612, 685-690 (2022).
15. B. Grigoryan, S. J. Paulsen, D. C. Corbett, D. W. Sazer, C. L. Fortin, A. J. Zaita, P. T. Greenfield, N. J. Calafat, J. P. Gounley, A. H. Ta, F. Johansson, A. Randles, J. E. Rosenkrantz, J. D. Louis-Rosenberg, P. A. Galie, K. R. Stevens, J. S. Miller, Multivascular networks and functional intravascular topologies within biocompatible hydrogels. Science. 364, 458-464 (2019).
16. J. Kim, G. Zhang, M. Shi, Z. Suo, Fracture, fatigue, and friction of polymers in which entanglements greatly outnumber cross-links. Science. 374, 212-216 (2021).
17. C. Liu, N. Morimoto, L. Jiang, S. Kawahara, T. Noritomi, H. Yokoyama, K. Mayumi, K. Ito, Tough hydrogels with rapid self-reinforcement. Science. 372, 1078-1081 (2021).
18. C. Qiao, S. Jiang, D. Dong, X. Ji, L. An, B. Jiang, The critical lowest molecular weight for PEG to crystallize in cross-linked networks. Macromol Rapid Commun. 25, 659-663 (2004).
19. W. F. M. M. Daniel, J. Burdyńska, M. Vatankhah-Varnoosfaderani, K. Matyjaszewski, J. Paturej, M. Rubinstein, A. V. Dobrynin, S. S. Sheiko, Solvent-free, supersoft and superelastic bottlebrush melts and networks. Nat Mater. 15, 183-189 (2016).
20. J. M. Sarapas, T. B. Martin, A. Chremos, J. F. Douglas, K. L. Beers, Bottlebrush polymers in the melt and polyelectrolytes in solution share common structural features. Proc Natl Acad Sci USA. 117, 5168-5175 (2020).
21. J. J. Paturej, S. S. Sheiko, S. Panyukov, M. Rubinstein, Molecular structure of bottlebrush polymers in melts. Sci Adv. 2, e1601478 (2016).
22. L.-H. Cai, T. E. Kodger, R. E. Guerra, A. F. Pegoraro, M. Rubinstein, D. A. Weitz, Soft Poly(dimethylsiloxane) elastomers from architecture-driven entanglement free design. Adv Mater. 27, 5132-5140 (2015).
23. S. Nian, H. Lian, Z. Gong, M. Zhernenkov, J. Qin, L. H. Cai, Molecular architecture directs linear-bottlebrush-linear triblock copolymers to self-assemble to soft reprocessable elastomers. ACS Macro Lett. 8, 1528-1534 (2019).
24. L. H. Cai, Molecular understanding for large deformations of soft bottlebrush polymer networks. Soft Matter. 16, 6259-6264 (2020).
25. S. Nian, J. Zhu, H. Zhang, Z. Gong, G. Freychet, M. Zhernenkov, B. Xu, L. H. Cai, Three-dimensional printable, extremely soft, stretchable, and reversible elastomers from molecular architecture-directed assembly. Chem Mater. 33, 2436-2445 (2021).
26. S. Nian, Z. Fan, G. Freychet, M. Zhernenkov, S. Redemann, L. H. Cai, Self-assembly of flexible linear-semiflexible bottlebrush-flexible linear triblock copolymers. Macromolecules. 54, 9361-9371 (2021).
27. S. Nian, L.-H. Cai, Dynamic mechanical properties of self-assembled bottlebrush polymer networks. Macromolecules. 55, 8058-8066 (2022).
28. S. Nian, B. Huang, G. Freychet, M. Zhernenkov, L.-H. Cai, Unexpected folding of bottlebrush polymers in melts. Macromolecules. 56, 2551-2559 (2023).
29. L.-H. Cai, Molecular structure of foldable bottlebrush polymers in melts. Macromolecules (2025), doi: 10.1021/acs.macromol.4c02981.
30. B. Huang, S. Nian, L.-H. Cai, A universal strategy for decoupling stiffness and extensibility of polymer networks. Sci Adv. 10, eadq3080 (2024).
31. M. Rubinstein, R. H. Colby, Polymer Physics (Oxford University Press, Oxford, U K, 2003).
32. I. Levental, P. C. Georges, P. A. Janmey, Soft biological materials and their impact on cell function. Soft Matter. 3, 1-9 (2007).
33. Z. J. He, B. Huang, L. H. Cai, Bottlebrush polyethylene glycol nanocarriers translocate across human airway epithelium via molecular architecture-enhanced endocytosis. ACS Nano. 18, 17586-17599 (2024).
34. C. M. Wijmans, E. B. Zhulina, Polymer brushes at curved surfaces. Macromolecules. 26, 7214-7224 (1993).
35. B. Button, L.-H. Cai, C. Ehre, M. Kesimer, D. B. Hill, J. K. Sheehan, R. C. Boucher, M. Rubinstein, A periciliary brush promotes the lung health by separating the mucus layer from airway epithelia. Science. 337, 937-941 (2012).
36. H. Lee, R. M. Venable, A. D. Mackerell, R. W. Pastor, Molecular dynamics studies of polyethylene oxide and polyethylene glycol: Hydrodynamic radius and shape anisotropy. Biophys J. 95, 1590-1599 (2008).
37. J. Zhu, Y. He, L. Kong, Z. He, K. Y. Kang, S. P. Grady, L. Q. Nguyen, D. Chen, Y. Wang, J. Oberholzer, L. H. Cai, Digital assembly of spherical viscoelastic bio-ink particles. Adv Funct Mater. 32, 1-11 (2022).
38. C. Creton, M. Ciccotti, Fracture and adhesion of soft materials: A review. Reports Prog Phys. 79, 046601 (2016).
39. J. Xia, L. H. Cai, H. Wu, F. C. Mackintosh, D. A. Weitz, Anomalous mechanics of Zn2+-modified fibrin networks. Proc Natl Acad Sci USA. 118, e2020541118 (2021).
40. R. G. Sousa, W. F. Magalhães, R. F. S. Freitas, Glass transition and thermal stability of poly(N-isopropylacrylamide) gels and some of their copolymers with acrylamide. Polym Degrad Stab. 61, 275-281 (1998).
41. Y. Akagi, T. Katashima, Y. Katsumoto, K. Fujii, T. Matsunaga, U. II Chung, M. Shibayama, T. Sakai, Examination of the theories of rubber elasticity using an ideal polymer network. Macromolecules. 44, 5817-5821 (2011).
42. K. Fujii, H. Asai, T. Ueki, T. Sakai, S. Imaizumi, U. II Chung, M.

Watanabe, M. Shibayama, High-performance ion gel with tetra-PEG network. Soft Matter. 8, 1756-1759 (2012).
43. M. Arreguín-Campos, M. Ebrahimi, A. Z. Dookhith, N. A. Lynd, G. E. Sanoja, A. A. Aldana, M. B. Baker, L. M. Pitet, Architectural differences in photopolymerized PEG-based thiol-acrylate hydrogels enable enhanced mechanical properties and 3D printability. Eur Polym J. 212, 113070 (2024).
44. D. Zhou, D. Shanmukaraj, A. Tkacheva, M. Armand, G. Wang, Polymer electrolytes for lithium-based batteries: advances and prospects. Chem. 5, 2326-2352 (2019).
45. B. Yiming, Y. Han, Z. Han, X. Zhang, Y. Li, W. Lian, M. Zhang, J. Yin, T. Sun, Z. Wu, T. Li, J. Fu, Z. Jia, S. Qu, A mechanically robust and versatile liquid-free ionic conductive elastomer. Adv Mater. 33, 2006111 (2021).
46. Q. Li, Z. Liu, S. Zheng, W. Li, Y. Ren, L. Li, F. Yan, Three-dimensional printable, highly conductive ionic elastomers for high-sensitivity iontronics. ACS Appl Mater Interfaces. 14, 26068-26076 (2022).
47. X. He, J. Cheng, Z. Li, H. Ye, Z. Sun, Q. Liu, H. Li, R. Wang, Q. Gₑ, Stretchable ultraviolet curable ionic conductive elastomers for digital light processing based 3D printing. Adv Mater Technol. 8, 1-8 (2023).
48. S. Narute, J. M. Angel, T. Kyu, Highly conductive, stretchable block copolymer based elastomeric networks for lithium ion batteries. Electrochim Acta. 443, 141962 (2023).
49. C. Wang, X. Duan, X. Li, W. Pan, C. Ning, F. Wang, W. Cao, F. Ou, M. Wang, Q. Liang, W. Gao, Z. Li, S. Zhao, A self-healing solid-state ion-conductive elastomer with high mechanical robustness and high conductivity for soft ionotronics. Adv Funct Mater. 34, 2402815 (2024).
50. W. Qiu, C. Zhang, Q. Zhang, Versatile Copolymer for Stretchable and Self-healable Liquid-free lonic Conductive Elastomers. ACS Appl Mater Interfaces. 14, 42578-42585 (2022).
51. M. A. Skylar-Scott, J. Mueller, C. W. Visser, J. A. Lewis, Voxelated soft matter via multimaterial multinozzle 3D printing. Nature. 575, 330-335 (2019).
52. J. E. Saik, D. J. Gould, E. M. Watkins, M. E. Dickinson, J. L. West, Covalently immobilized platelet-derived growth factor-BB promotes angiogenesis in biomimetic poly(ethylene glycol) hydrogels. Acta Biomater. 7, 133-143 (2011).
53. M. Wang, P. Zhang, M. Shamsi, J. L. Thelen, W. Qian, V. K. Truong, J. Ma, J. Hu, M. D. Dickey, Tough and stretchable ionogels by in situ phase separation. Nat Mater. 21, 359-365 (2022).
54. C. Yang, Z. Suo, Hydrogel ionotronics. Nat Rev Mater. 3, 125-142 (2018).
55. Y. Kim, X. Zhao, Magnetic soft materials and robots. Chem Rev. 122, 5317-5364 (2022).
56. S. Wang, J. Y. Oh, J. Xu, H. Tran, Z. Bao, Skin-inspired electronics: an emerging paradigm. Acc Chem Res. 51, 1033-1045 (2018).
57. D. A. Rau, M. Kim, B. Xu, L.-H. Cai, Modular soft stretchable low-cost elastomers for stereolithography printing structures with extreme dissipative properties (2024), doi: 10.26434/chemrxiv-2024-pj7s0.

### Supplemental Information for Example 1

The flexibility K of a polymer is defined as the ratio of its contour length [symbol] ₘₐₓ to twice the persistence length [symbol] ₚ,

$$κ ≡ \frac{{ℒ}_{max}}{2 {ℓ}_{p}} \qquad ( S1 )$$

For a semiflexible polymer, κ≈ 1; for a stiff polymer, κ<1.

We extend our previously developed theory (33) to calculate the persistent length of a polyethylene glycol (PEG) bottlebrush polymer in water. In a bottlebrush polymer, the side chains highly overlap with each other, resulting in steric repulsion so that the side chains extend away from the bottlebrush backbone, forming a cylindrical shape with the cross-section comparable to the side chain size. Thus, a bottlebrush polymer is effectively a ‘fat’ linear polymer with persistence length on the order of the side chain size.

To calculate the size of a side chain, R_{sc}, we consider the profile of the volume fraction, ϕ(r), of the side chains at the distance r from the bottlebrush backbone.

$$\begin{matrix}ϕ ( r ) \approx \frac{{b}^{3} g ( r )}{{ξ}^{3} ( r )} , & for r > b\end{matrix} \qquad ( S2 )$$

Here, b is the Kuhn monomer size, g(r) is the number of monomers per correlation blob, ξ(r)≈bg^{v}(r) is the correlation length, and v is the Flory exponent depending on solvent quality (for theta solvent v=1/2 and for a good or athermal solvent v=3/5) (31).

$$\begin{matrix}ϕ ( r ) \approx {[ \frac{ξ ( r )}{b} ]}^{( 1 - 3 v ) / v} , & for r > b\end{matrix} \qquad ( S3 )$$

Within the cylinder-like bottlebrush polymer, the correlation length is related to the linear grafting density 1/l of side chains (34, 35):

$$\begin{matrix}ξ ( r ) \approx {( rl )}^{1 / 2} , & for r > b\end{matrix} \qquad ( S4 )$$

which increases the distance r by a power of 1/2. Note that in our bottlebrush polyethylene glycol (PEG) polymer, the grafting distance is very small with l=0.254 nm, much smaller than the size b=1.1 nm of a PEG Kuhn segment (36, 37). At the length scale r<b, the side chains fill the space to form an exclusion zone for solvents. However, the exclusion zone is very small, on the order of Kuhn monomer size. Thus, we ignore the effect of exclusion zone on the bottlebrush thickness and focus on the region with r>b, where the polymer chains interact with solvent molecules.

Substituting eq. (S4) to eq. (S3), the profile of polymer volume fraction can be re-written in terms of the distance r from the bottlebrush backbone:

$$\begin{matrix}ϕ ( r ) \approx {( \frac{rl}{{b}^{2}} )}^{( 1 - 3 v ) / 2 v} , & for r > b\end{matrix} \qquad ( S5 )$$

The size of a side chain, R_{sc}, can be determined based on mass conservation:

$${\int }_{b}^{{R}_{sc}} ϕ ( r ) {ξ}^{2} ( r ) dr \approx {N}_{k , sc} {b}^{3} \qquad ( S6 )$$

where N_{k,sc} is the number of Kuhn monomers per side chain. Solving eq. (S4) one obtains:

$${R}_{sc} \approx {( \frac{b}{l} )}^{\frac{1 - v}{2 v}} {b ( {N}_{k , sc} )}^{\frac{2 v}{1 + v}} \qquad ( S7 )$$

Since water is a good solvent for PEG (v=3/5), the size of the side chain can be re-written as:

$${R}_{sc} \approx {( \frac{b}{l} )}^{\frac{1}{4}} {bN}_{k , sc}^{\frac{3}{4}} , for good or athermal solvent \qquad ( S8 )$$

This suggests that the side chain size not only increases with the grafting density 1/l but also scales with the polymer MW by a power of ¾, higher than ⅗ for an unperturbed linear chain in good solvent.

For PEG, the size and mass of a Kuhn monomer are, respectively, b=11 Å and M₀=137 g/mol (Table 2.1 in ref. (31)). For the bottlebrush PEG polymer, the grafting distance is l=0.254 nm, the number of Kuhn monomers per side chain is N_{k,sc}=M_{sc}/M₀≈3.5, in which M_{sc}=480 g/mol is the molecular weight of a PEG side chain. Substituting these numbers into eq. (S8), one obtains the persistence length of the bottlebrush, [symbol] p≈R_{sc}≈4 nm.

TABLE S1
List of data points and references for FIG. 3J

| | | 3D | | Young's | Tensile | |
|---|---|---|---|---|---|---|
| | | Print- | Symbol | modulus | breaking | |
| | Material | able | color | (kPa) | strain | Reference |
| Slide-ring | PEG with | No | Green | 129.9 | 14.4 | Ref. (17) |
| PEG | hydroxypropyl- | | | 249.9 | 12.9 | |
| hydrogels | α-cyclodextrin | | | 333.3 | 12.4 | |
| PEG | Tetra arm PEG | No | Grey | 23.6 | 4.0 | Ref. (41) |
| hydrogels | | | (with | 2.8 | 3.8 | Ref. (42) |
| | | | outer | 7.7 | 3.0 | |
| | | | border) | | | |
| | PEGMA | Yes | Grey | 0.3 | 0.6 | Ref. (43) |
| | | | | 0.5 | 0.6 | |
| | | | | 0.2 | 2.3 | |
| | PEGMA + 3 | | | 120.6 | 0.9 | |
| | arm-PEG-SH | | | 100.0 | 4.3 | |
| | | | | 80.0 | 3.2 | |
| | | | | 0.2 | 0.4 | |
| | | | | 0.2 | 3.9 | |
| | | | | 0.08 | 2.8 | |
| | PEGDA, and | | | 34200.0 | 0.1 | Ref. (12) |
| | PEGMA | | | 6600.0 | 0.3 | |
| | | | | 3200.0 | 0.4 | |
| | | | | 1200.0 | 0.6 | |
| | | | | 1400.0 | 0.7 | |
| | | | | 400.0 | 0.6 | |
| | | | | 2500.0 | 0.5 | |
| | | | | 3700.0 | 0.4 | |
| | | | | 5300.0 | 0.3 | |

TABLE S2
List of data points and references for FIG. 4C

| | Ionic | | | Ionic | Tensile | |
|---|---|---|---|---|---|---|
| | conducting | Symbol | Symbol | conductivity | breaking | Reference |
| Matrix polymer | material | shape | color | (S/cm) | strain | Number |
| Ethylene glycol | LiTFSI | Square | Black | 4 × 10⁻⁶ | 17.0 | Ref. (45) |
| methyl ether | | (□) | | 1 × 10⁻⁵ | | |
| acrylate (MEA) + | | | | 2 × 10⁻⁵ | 18.0 | |
| isobornyl | | | | 6 × 10⁻⁵ | 16.0 | |
| acrylate (IBA) | | | | | 16.0 | |
| Ethyl acrylate | LiTFSI | Triangle | Navy | 3 × 10⁻⁶ | 6.6 | Ref. (46) |
| (EA) + | | ( [symbol] ) | | 1 × 10⁻⁵ | 5.9 | |
| hydroxyethyl | | | | 2 × 10⁻⁶ | 4.5 | |
| acrylate (HEA) | | | | 2 × 10⁻⁶ | 5.9 | |
| | | | | 1.7 × 10⁻⁵ | 7.5 | |
| | | | | 1.8 × 10⁻⁵ | 10.5 | |
| Butyl acrylate | LiTFSI | Triangle | Red | 1.5 × 10⁻⁶ | 4.0 | Ref. (47) |
| (BA) | | (◯) | | 4 × 10⁻⁶ | 4.5 | |
| | | | | 7 × 10⁻⁶ | 5.5 | |
| | | | | 3 × 10⁻⁵ | 6.0 | |
| | | | | 8 × 10⁻⁵ | 7.0 | |
| PEG based | LiTFSI | Hexagram | Grey | 1 × 10⁻³ | 1.2 | Ref. (48) |
| block copolymer | | ( [symbol] ) | | | | |
| Polyurethane | LiTFSI | Triangle | Black | 8.4 × 10⁻⁵ | 13.6 | Ref. (49) |
| (PU) + | | right | | 1.4 × 10⁻⁴ | 15.5 | |
| polyethylene | | ( [symbol] ) | | 1.5 × 10⁻⁴ | 11.9 | |
| glycol (PEG) | | | | | | |
| poly(ethylene | [2- | Triangle | Red | 5 × 10⁻⁶ | 9.0 | Ref. (50) |
| glycol) methyl | (Acryloyloxy) | right | | 1.8 × 10⁻⁶ | 15.0 | |
| ether acrylate | ethyl] | ( [symbol] ) | | 1.5 × 10⁻⁶ | 15.0 | |
| (PEGMA) + | trimethyl | | | 1.3 × 10⁻⁶ | 13.0 | |
| benzyl | ammonium | | | 9.7 × 10⁻⁷ | 18.0 | |
| acrylate | chloride | | | | | |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”. In addition, “about 0” is greater than 0 but not 0.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A composition comprising:
a foldable bottlebrush polymer network, wherein the foldable bottlebrush polymer network includes at least one polymer strand, wherein the polymer strand includes a polymer backbone having a spacer unit and a monofunctional polyethylene glycol (PEG) side chain, wherein the foldable bottlebrush polymer network has at least two of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ration (rₛₚ) of about 1 to 5, and an average number of side chains per foldable bottlebrush polymer network strand (n_{sc}) of about 20 to 1000.

2. The composition of claim 1, wherein the foldable bottlebrush polymer network has at least three of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ration (rₛₚ) of about 1 to 5, and an average number of side chains per foldable bottlebrush polymer network strand (n_{sc}) of about 20 to 1000.

3. The composition of claim 1, wherein the foldable bottlebrush polymer network has each of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ration (rₛₚ) of about 1 to 5, and an average number of side chains per foldable bottlebrush polymer network strand (n_{sc}) of about 20 to 1000.

4. The composition of claim 1, wherein the polymer strand has the following structure: 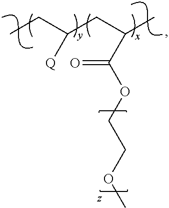
wherein Q is the spacer, wherein y is 1 to 10, x is 50 to 5000, and z is 1 to 200.

5. The composition of claim 1, wherein the polymer strand has the following structure: 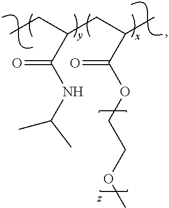
wherein y is 1 to 10, x is 50 to 5000, and z is 1 to 200.

6. The composition of claim 1, wherein the spacer unit is selected from the group consisting of: N-isopropylacrylamide, a vinyl-based unit, an olefin-based unit, an acrylate-based unit, an alkyl acrylate-based unit, an acrylamide-based unit, an alkyl acrylamide-based unit, an allyl acrylamide-based unit, an urethane-based unit, a silane-based unit, a siloxane-based unit, a styrene-based unit, a maleimide-based unit, an imide-based unit, an epoxy-based unit, a norbornene-based units, and a derivative of each of these.

7. The composition of claim 1, wherein the rₛₚ is about 3 to 5, wherein the tensile breaking strain of 1000 to 1500%, wherein the Young's modulus of about 5 kPa to 15 kPa.

8. The composition of claim 1, wherein the tensile breaking strain of 800 to 1100%, and conductivity of about 1.1 to 1.3 mS/cm.

9. The composition of claim 1, wherein the composition is solvent-free.

10. A method of making a foldable bottlebrush polymer network, comprising:
mixing a spacer unit monomer, a monofunctional polyethylene glycol (PEG) side chain monomer, a difunctional PEG crosslinker unit monomer, and a photoinitiator to form a photocurable resin;
disposing the photocurable resin onto a surface; and
exposing the photocurable resin for a time period to form a composition including the foldable bottlebrush polymer network.

11. The method of claim 10, wherein the foldable bottlebrush polymer network includes at least one polymer strand, wherein the polymer strand includes a polymer backbone having a spacer unit and a monofunctional polyethylene glycol (PEG) side chain, wherein the foldable bottlebrush polymer network has at least two of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ration (rₛₚ) of about 1 to 5, and an average number of side chains per foldable bottlebrush polymer network strand (n_{sc}) of about 20 to 1000.

12. The method of claim 10, wherein the time period is 5 to 15 seconds.

13. The method of claim 10, wherein the spacer unit is selected from the group consisting of: N-isopropylacrylamide, a vinyl-based unit, an olefin-based unit, an acrylate-based unit, an alkyl acrylate-based unit, an acrylamide-based unit, an alkyl acrylamide-based unit, an allyl acrylamide-based unit, an urethane-based unit, a silane-based unit, a siloxane-based unit, a styrene-based unit, a maleimide-based unit, an imide-based unit, an epoxy-based unit, a norbornene-based units, and a derivative of each of these.

14. The method of claim 13, wherein the monofunctional polyethylene glycol (PEG) side chain monomer has the following structure: 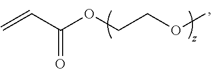
wherein z is 1 to 200;
wherein the difunctional PEG crosslinker unit monomer has the following structure: 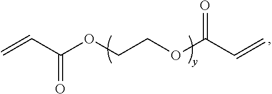
wherein y is 50 to 5000,
wherein y is greater than z.

15. The method of claim 10, wherein mixing includes mixing a lithium salt, the spacer unit monomer, the monofunctional polyethylene glycol (PEG) side chain monomer, the difunctional PEG crosslinker unit monomer, and the photoinitiator to form the photocurable resin.

16. A conductive electrolyte comprising a composition that includes a lithium salt and a foldable bottlebrush polymer network, wherein the foldable bottlebrush polymer network includes at least one polymer strand, wherein the polymer strand includes a polymer backbone having a spacer unit and a monofunctional polyethylene glycol (PEG) side chain, wherein the foldable bottlebrush polymer network has at least two of the following characteristics: a Young's modulus of about 600 Pa to 100 kPa, a tensile breaking strain of 20 to 1500%, a molecular weight of about 1000 kDa to 10,000 kDa, a conductivity of about 1 to 1.4 mS/cm, a glass transition temperature of about −60 to −70° C., a crystallization point of about −30 to −40° C., a spacer/side chain molar ration (rₛₚ) of about 1 to 5, and an average number of side chains per foldable bottlebrush polymer network strand (n_{sc}) of about 20 to 1000.

17. The conductive electrolyte of claim 16, wherein the composition is solvent-free.

18. The conductive electrolyte of claim 16, wherein the composition is within a lithium battery.

19. The conductive electrolyte of claim 16, wherein the foldable bottlebrush polymer network has a conductivity of about 1.1 to 1.3 mS/cm and has a tensile breaking strain of 800 to 1100%.
